(19) United States
(12) Patent Application Publication
(10) Pub. No.: US 2016/0144461 A1
(43) Pub. Date: May 26, 2016

(54) Ni-Cr-Mo-Ta-Nb Welding Filler Metals, Welding Filler Metal Consumables, Weld Deposits, Methods of Making Weld Deposits, and Weldments Thereof

(71) Applicant: Huntington Alloys Corporation, Huntington, WV (US)

(72) Inventors: Samuel D. Kiser, Lenoir, NC (US); Brian A. Baker, Kitts Hill, OH (US)

(21) Appl. No.: 14/948,883

(22) Filed: Nov. 23, 2015

Related U.S. Application Data
(60) Provisional application No. 62/082,833, filed on Nov. 21, 2014.

(51) Int. Cl. B23K 35/22; B23K 9/16

(52) U.S. Cl. CPC B23K 35/22; B23K 9/16

(57) ABSTRACT

A welding filler metal includes, by weight percent: chromium of at least 28.0% and at most 31.5%; niobium of at least 0.60%; tantalum of at least 0.010%; molybdenum of at least 1.0% and at most 7.0%; carbon of at least 0.040% and at most 0.09%; manganese of at most 1.0%; balance nickel and inevitable impurities, wherein the sum of niobium and tantalum is at least 2.2% and at most 4.0%. A welding filler metal consumable is made from the welding filler metal. A welding deposit is formed from the welding filler metal consumable. A weldment is formed using the welding filler metal consumable.

### CROSS REFERENCE TO RELATED APPLICATION

This application claims priority to U.S. Provisional Patent Application No. 62/082,833 filed Nov. 21, 2014, the disclosure of which is hereby incorporated by reference for all purposes in its entirety.

### BACKGROUND OF THE INVENTION

1. Field of the Invention

The invention relates to Ni—Cr—Mo—Ta—Nb welding filler metals, welding filler metal consumables, weld deposits, methods of making weld deposits, and weldments thereof.

2. Description of Related Art

INCONEL® Filler Metal 52 is a 30% chromium welding filler metal consumable designed to provide resistance to primary water stress corrosion cracking (PWSCC). The limiting chemical composition is, by weight percent: Ni+Co: remainder; C: 0.04% max.; Mn: 1.0% max.; Fe: 7.0 to 11.0%; S: 0.015% max; Si: 0.50% max; Mo: 0.30%; Cu: 0.30% max; Cr: 28.0-31.5%; Ti: 1.0% max; Al: 1.10% max; P: 0.02% max; Nb+Ta: 0.10% max.; Al+Ti: 1.5% max; Others: 0.50% max. However, while Filler Metal 52 exhibits resistance to PWSCC, Filler Metal 52 is subject to hot cracking and ductility dip cracking (DDC).

INCONEL® Filler Metal 52M is a 30% chromium welding filler metal consumable designed to resist PWSCC and exhibit excellent resistance to hot cracking. The limiting chemical composition is, by weight percent: Ni: remainder; C: 0.04% max.; Mn: 1.0% max.; Fe: 7.0 to 11.0%; S: 0.015% max; Si: 0.50% max; Cu: 0.30% max; Cr: 28.0-31.5%; Al: 1.10% max; Ti: 1.0% max; Co: 0.12% max.; Nb: 0.50 to 1.0%; P: 0.02% max; Zr: 0.02% max; B: 0.005% max; Mo: 0.50%; Others: 0.50% max. However, while Filler Metal 52M exhibits excellent resistance to hot cracking in undiluted welds due to a laves-free microstructure, Filler Metal 52M is subject to DDC.

INCONEL® Filler Metal 52MSS is a 30% chromium welding filler metal consumable designed to resist PWSCC and has excellent resistance to DDC. The limiting chemical composition is, by weight percent: Ni+Co: 52.0 to 62.0%; C: 0.03% max.; Mn: 1.0% max.; Fe: balance; S: 0.015% max; Si: 0.50% max; Mo: 3.0-5.0%; Cu: 0.30% max; Cr: 28.5 to 31.5%; Ti: 0.50% max; Al: 0.50% max; P: 0.02% max; Nb+Ta: 1.5 to 3.5%; others: 0.50% max. However, while Filler Metal 52MSS exhibits excellent resistance to DDC, Filler Metal 52MSS has a slight tendency for hot cracking due to the presence of small amounts of laves phases in the microstructure.

### SUMMARY OF THE INVENTION

There is a desire to provide a welding filler metal having excellent resistance to ductility-dip cracking (DDC) and excellent resistance to hot-cracking while continuing to provide resistance to primary water stress corrosion cracking (PWSCC).

Thus, the present inventors sought to design welding filler metals, welding filler metal consumables, weld deposits, methods of making weld deposits, and weldments that overcome one or more problems of the prior art.

According to exemplary embodiments and the following numbered clauses, the invention may include but is not limited to:

Clause 1: A welding filler metal comprising, by weight percent: chromium of at least 28.0% and at most 31.5%; niobium of at least 0.60%; tantalum of at least 0.010%; molybdenum of at least 1.0% and at most 7.0%; carbon of at least 0.040% and at most 0.09%; manganese of at most 1.0%; balance nickel and inevitable impurities, wherein the sum of niobium and tantalum is at least 2.2% and at most 4.0%.

Clause 2: The welding filler metal of clause 1, wherein the chromium content is at least 28.5%.

Clause 3: The welding filler metal of clause 1, wherein the chromium content is at least 29.0%.

Clause 4: The welding filler metal of clause 1, wherein the chromium content is at least 29.5%.

Clause 5: The welding filler metal of clause 1, wherein the chromium content is at least 30.0%.

Clause 6: The welding filler metal of any one of clauses 1 to 5, wherein the chromium content is at most 31.0%.

Clause 7: The welding filler metal of any one of clauses 1 to 6, wherein the niobium content is at least 0.70%.

Clause 8: The welding filler metal of any one of clauses 1 to 7, wherein the niobium content is at most 3.9%.

Clause 9: The welding filler metal of any one of clauses 1 to 7, wherein the niobium content is at most 3.0%.

Clause 10: The welding filler metal of any one of clauses 1 to 7, wherein the niobium content is at most 2.3%.

Clause 11: The welding filler metal of any one of clauses 1 to 7, wherein the niobium content is at most 1.5%.

Clause 12: The welding filler metal of any one of clauses 1 to 7, wherein the niobium content is at most 1.0%.

Clause 13: The welding filler metal of any one of clauses 1 to 7, wherein the niobium content is at most 0.8%.

Clause 14: The welding filler metal of any one of clauses 1 to 13, wherein the tantalum content is at least 0.10%.

Clause 15: The welding filler metal of any one of clauses 1 to 13, wherein the tantalum content is at least 0.50%.

Clause 16: The welding filler metal of any one of clauses 1 to 13, wherein the tantalum content is at least 1.0%.

Clause 17: The welding filler metal of any one of clauses 1 to 13, wherein the tantalum content is at least 1.5%.

Clause 18: The welding filler metal of any one of clauses 1 to 17, wherein the tantalum content is at most 3.2%.

Clause 19: The welding filler metal of any one of clauses 1 to 17, wherein the tantalum content is at most 2.5%.

Clause 20: The welding filler metal of any one of clauses 1 to 17, wherein the tantalum content is at most 2.0%.

Clause 21: The welding filler metal of any one of clauses 1 to 17, wherein the tantalum content is at most 1.6%.

Clause 22: The welding filler metal of any one of clauses 1 to 21, wherein the sum of the niobium and tantalum contents is at most 3.5%.

Clause 23: The welding filler metal of any one of clauses 1 to 21, wherein the sum of the niobium and tantalum contents is at most 3.0%.

Clause 24: The welding filler metal of any one of clauses 1 to 21, wherein the sum of the niobium and tantalum contents is at most 2.7%.

Clause 25: The welding filler metal of any one of clauses 1 to 21, wherein the sum of the niobium and tantalum contents is at most 2.4%.

Clause 26: The welding filler metal of any one of clauses 1 to 25, wherein the molybdenum content is at least 1.5%.

Clause 27: The welding filler metal of any one of clauses 1 to 25, wherein the molybdenum content is at least 2.0%.

Clause 28: The welding filler metal of any one of clauses 1 to 25, wherein the molybdenum content is at least 2.6%.

Clause 29: The welding filler metal of any one of clauses 1 to 25, wherein the molybdenum content is at least 3.1%.

Clause 30: The welding filler metal of any one of clauses 1 to 29, wherein the molybdenum content is at most 6.0%.

Clause 31: The welding filler metal of any one of clauses 1 to 29, wherein the molybdenum content is at most 5.0%.

Clause 32: The welding filler metal of any one of clauses 1 to 29, wherein the molybdenum content is at most 4.0%.

Clause 33: The welding filler metal of any one of clauses 1 to 29, wherein the molybdenum content is at most 3.3%.

Clause 34: The welding filler metal of any one of clauses 1 to 33, wherein the carbon content is at least 0.045%.

Clause 35: The welding filler metal of any one of clauses 1 to 33, wherein the carbon content is at least 0.050%.

Clause 36: The welding filler metal of any one of clauses 1 to 33, wherein the carbon content is at least 0.055%.

Clause 37: The welding filler metal of any one of clauses 1 to 33, wherein the carbon content is at least 0.060%.

Clause 38: The welding filler metal of any one of clauses 1 to 33, wherein the carbon content is at least 0.065%.

Clause 39: The welding filler metal of any one of clauses 1 to 33, wherein the carbon content is at least 0.070%.

Clause 40: The welding filler metal of any one of clauses 1 to 39, wherein the carbon content is at most 0.085%.

Clause 41: The welding filler metal of any one of clauses 1 to 39, wherein the carbon content is at most 0.080%.

Clause 42: The welding filler metal of any one of clauses 1 to 41, wherein the manganese content is at least 0.0010%.

Clause 43: The welding filler metal of any one of clauses 1 to 41, wherein the manganese content is at least 0.01%.

Clause 44: The welding filler metal of any one of clauses 1 to 41, wherein the manganese content is at least 0.10%.

Clause 45: The welding filler metal of any one of clauses 1 to 41, wherein the manganese content is at least 0.20%.

Clause 46: The welding filler metal of any one of clauses 1 to 45, wherein the manganese content is at most 0.75%.

Clause 47: The welding filler metal of any one of clauses 1 to 45, wherein the manganese content is at most 0.50%.

Clause 48: The welding filler metal of any one of clauses 1 to 45, wherein the manganese content is at most 0.40%.

Clause 49: The welding filler metal of any one of clauses 1 to 48, further comprising aluminum of at least 0.0010%.

Clause 50: The welding filler metal of any one of clauses 1 to 48, further comprising aluminum of at least 0.01%.

Clause 51: The welding filler metal of any one of clauses 1 to 48, further comprising aluminum of at least 0.10%.

Clause 52: The welding filler metal of any one of clauses 1 to 51, further comprising aluminum of at most 0.50%.

Clause 53: The welding filler metal of any one of clauses 1 to 51, further comprising aluminum of at most 0.40%.

Clause 54: The welding filler metal of any one of clauses 1 to 51, further comprising aluminum of at most 0.25%.

Clause 55: The welding filler metal of any one of clauses 1 to 51, further comprising aluminum of at most 0.15%.

Clause 56: The welding filler metal of any one of clauses 1 to 55, further comprising titanium of at most 0.50%.

Clause 57: The welding filler metal of any one of clauses 1 to 56, further comprising titanium of at most 0.40%.

Clause 58: The welding filler metal of any one of clauses 1 to 56, further comprising titanium of at most 0.35%.

Clause 59: The welding filler metal of any one of clauses 1 to 56, further comprising titanium of at most 0.30%.

Clause 60: The welding filler metal of any one of clauses 1 to 59, further comprising boron of at most 0.0150%.

Clause 61: The welding filler metal of any one of clauses 1 to 59, further comprising boron of at most 0.0050%.

Clause 62: The welding filler metal of any one of clauses 1 to 59, further comprising boron of at most 0.0010%.

Clause 63: The welding filler metal of any one of clauses 1 to 59, further comprising boron of at most 0.0005%.

Clause 64: The welding filler metal of any one of clauses 1 to 63, further comprising zirconium of at most 0.020%.

Clause 65: The welding filler metal of any one of clauses 1 to 63, further comprising zirconium of at most 0.010%.

Clause 66: The welding filler metal of any one of clauses 1 to 63, further comprising zirconium of at most 0.0050%.

Clause 67: The welding filler metal of any one of clauses 1 to 63, further comprising zirconium of at most 0.0010%.

Clause 68: The welding filler metal of any one of clauses 1 to 67, further comprising sulfur of at most 0.015%.

Clause 69: The welding filler metal of any one of clauses 1 to 67, further comprising sulfur of at most 0.010%.

Clause 70: The welding filler metal of any one of clauses 1 to 67, further comprising sulfur of at most 0.0050%.

Clause 71: The welding filler metal of any one of clauses 1 to 67, further comprising sulfur of at most 0.0010%.

Clause 72: The welding filler metal of any one of clauses 1 to 71, further comprising phosphorus of at most 0.020%.

Clause 73: The welding filler metal of any one of clauses 1 to 71, further comprising phosphorus of at most 0.010%.

Clause 74: The welding filler metal of any one of clauses 1 to 71, further comprising phosphorus of at most 0.003%.

Clause 75: The welding filler metal of any one of clauses 1 to 74, further comprising silicon of at least 0.0010%.

Clause 76: The welding filler metal of any one of clauses 1 to 74, further comprising silicon of at least 0.010%.

Clause 77: The welding filler metal of any one of clauses 1 to 74, further comprising silicon of at least 0.020%.

Clause 78: The welding filler metal of any one of clauses 1 to 77, further comprising silicon of at most 0.50%.

Clause 79: The welding filler metal of any one of clauses 1 to 77, further comprising silicon of at most 0.25%.

Clause 80: The welding filler metal of any one of clauses 1 to 77, further comprising silicon of at most 0.15%.

Clause 81: The welding filler metal of any one of clauses 1 to 80, further comprising copper of at most 1.0%.

Clause 82: The welding filler metal of any one of clauses 1 to 80, further comprising copper of at most 0.5%.

Clause 83: The welding filler metal of any one of clauses 1 to 80, further comprising copper of at most 0.3%.

Clause 84: The welding filler metal of any one of clauses 1 to 80, further comprising copper of at most 0.10%.

Clause 85: The welding filler metal of any one of clauses 1 to 80, further comprising copper of at most 0.030%.

Clause 86: The welding filler metal of any one of clauses 1 to 85, further comprising cobalt of at most 0.20%.

Clause 87: The welding filler metal of any one of clauses 1 to 85, further comprising cobalt of at most 0.10%.

Clause 88: The welding filler metal of any one of clauses 1 to 85, further comprising cobalt of at most 0.05%.

Clause 89: The welding filler metal of any one of clauses 1 to 85, further comprising cobalt of at most 0.010%.

Clause 90: The welding filler metal of any one of clauses 1 to 89, further comprising tungsten of at most 1.0%.

Clause 91: The welding filler metal of any one of clauses 1 to 89, further comprising tungsten of at most 0.5%.

Clause 92: The welding filler metal of any one of clauses 1 to 89, further comprising tungsten of at most 0.25%.

Clause 93: The welding filler metal of any one of clauses 1 to 92, further comprising iron of at least 1.0%.

Clause 94: The welding filler metal of any one of clauses 1 to 92, further comprising iron of at least 3.0%.

Clause 95: The welding filler metal of any one of clauses 1 to 92, further comprising iron of at least 5.0%.

Clause 96: The welding filler metal of any one of clauses 1 to 92, further comprising iron of at least 5.5%.

Clause 97: The welding filler metal of any one of clauses 1 to 96, further comprising iron of at most 16.0%.

Clause 98: The welding filler metal of any one of clauses 1 to 96, further comprising iron of at most 13.0%.

Clause 99: The welding filler metal of any one of clauses 1 to 96, further comprising iron of at most 10.0%.

Clause 100: The welding filler metal of any one of clauses 1 to 96, further comprising iron of at most 8.0%.

Clause 101: The welding filler metal of any one of clauses 1 to 96, further comprising iron of at most 7.0%.

Clause 102: The welding filler metal of any one of clauses 1 to 96, further comprising iron of at most 6.2%.

Clause 103: The welding filler metal of any one of clauses 1 to 102, wherein the nickel content is controlled to be at least 52.0%.

Clause 104: The welding filler metal of any one of clauses 1 to 102, wherein the nickel content is controlled to be at least 54.0%.

Clause 105: The welding filler metal of any one of clauses 1 to 102, wherein the nickel content is controlled to be at least 56.0%.

Clause 106: The welding filler metal of any one of clauses 1 to 105, wherein the nickel content is controlled to be at most 62.0%.

Clause 107: The welding filler metal of any one of clauses 1 to 105, wherein the nickel content is controlled to be at most 61.0%.

Clause 108: The welding filler metal of any one of clauses 1 to 105, wherein the nickel content is controlled to be at most 60.0%.

Clause 109: The welding filler metal of any one of clauses 1 to 108, wherein the calcium content is at most 0.010%.

Clause 110: The welding filler metal of any one of clauses 1 to 108, wherein the calcium content is at most 0.0050%.

Clause 111: The welding filler metal of any one of clauses 1 to 110, wherein the magnesium content is at most 0.020%.

Clause 112: The welding filler metal of any one of clauses 1 to 110, wherein the magnesium content is at most 0.010%.

Clause 113: The welding filler metal of any one of clauses 1 to 110, wherein the magnesium content is at most 0.0050%.

Clause 114: The welding filler metal of any one of clauses 1 to 113, wherein an amount of any single unrecited element is controlled to be at most 0.50%.

Clause 115: The welding filler metal of any one of clauses 1 to 113, wherein an amount of any single unrecited element is controlled to be at most 0.10%.

Clause 116: The welding filler metal of any one of clauses 1 to 113, wherein an amount of any single unrecited element is controlled to be at most 0.02%.

Clause 117: The welding filler metal of any one of clauses 1 to 116, wherein a total amount of any unrecited elements is controlled to be at most 0.50%.

Clause 118: The welding filler metal of any one of clauses 1 to 116, wherein a total amount of any unrecited elements is controlled to be at most 0.10%.

Clause 119: The welding filler metal of any one of clauses 1 to 116, wherein a total amount of any unrecited elements is controlled to be at most 0.02%.

Clause 120: The welding filler metal of any one of clauses 1 to 119, wherein a weld deposit made using the welding filler metal exhibits a tensile strength of at least 90 ksi.

Clause 121: The welding filler metal of any one of clauses 1 to 119, wherein a weld deposit made using the welding filler metal exhibits a tensile strength of at least 95 ksi.

Clause 122: The welding filler metal of any one of clauses 1 to 121, wherein a weld deposit made using the welding filler metal exhibits a percent elongation of at least 30%.

Clause 123: The welding filler metal of any one of clauses 1 to 121, wherein a weld deposit made using the welding filler metal exhibits a percent elongation of at least 35%.

Clause 124: The welding filler metal of any one of clauses 1 to 123, wherein a weld deposit made using the welding filler metal exhibits a hot cracking resistance as measured by a maximum crack distance (MCD) as determined by the transvarestraint test of 1.0 mm or less at 5% augmented strain.

Clause 125: The welding filler metal of any one of clauses 1 to 123, wherein a weld deposit made using the welding filler metal exhibits a hot cracking resistance as measured by a maximum crack distance (MCD) as determined by the transvarestraint test of 0.9 mm or less at 5% augmented strain.

Clause 126: The welding filler metal of any one of clauses 1 to 123, wherein a weld deposit made using the welding filler metal exhibits a hot cracking resistance as measured by a maximum crack distance (MCD) as determined by the transvarestraint test of 0.8 mm or less at 5% augmented strain.

Clause 127: The welding filler metal of any one of clauses 1 to 123, wherein a weld deposit made using the welding filler metal exhibits a hot cracking resistance as measured by a maximum crack distance (MCD) as determined by the transvarestraint test of 0.7 mm or less at 5% augmented strain.

Clause 128: The welding filler metal of any one of clauses 1 to 123, wherein a weld deposit made using the welding filler metal exhibits a hot cracking resistance as measured by a maximum crack distance (MCD) as determined by the transvarestraint test of 0.6 mm or less at 5% augmented strain.

Clause 129: The welding filler metal of any one of clauses 1 to 128, wherein a weld deposit made using the welding filler metal exhibits the DDC resistance as measured by the strain to fracture (STF) test exhibits a threshold strain value of 14% or greater at 950° C.

Clause 130: The welding filler metal of any one of clauses 1 to 128, wherein a weld deposit made using the welding filler metal exhibits the DDC resistance as measured by the strain to fracture (STF) test exhibits a threshold strain value of 15% or greater at 950° C.

Clause 131: The welding filler metal of any one of clauses 1 to 128, wherein a weld deposit made using the welding filler metal exhibits the DDC resistance as measured by the strain to fracture (STF) test exhibits a threshold strain value of 16% or greater at 950° C.

Clause 132: The welding filler metal of any one of clauses 1 to 128, wherein a weld deposit made using the welding filler metal exhibits the DDC resistance as measured by the strain to fracture (STF) test exhibits a threshold strain value of 17% or greater at 950° C.

Clause 133: The welding filler metal of any one of clauses 1 to 128, wherein a weld deposit made using the welding filler metal exhibits the DDC resistance as measured by the strain to fracture (STF) test exhibits a threshold strain value of 18% or greater at 950° C.

Clause 134: The welding filler metal of any one of clauses 1 to 133, wherein a weld deposit made using the welding filler metal exhibits the crack growth rate (CGR) under PWSCC conditions of 10⁻⁸ mm/second or less.

Clause 135: The welding filler metal of any one of clauses 1 to 133, wherein a weld deposit made using the welding filler metal exhibits the crack growth rate (CGR) under PWSCC conditions of 10⁻⁹ or mm/second or less.

Clause 136: A welding filler metal consumable made from the welding filler metal of any one of clauses 1 to 135.

Clause 137: The welding filler metal consumable of clause 136, wherein the welding filler metal consumable is in the form of a wire, strip, rod, electrode, pre-alloyed powder, or mixture of powders.

Clause 138: The welding filler metal consumable of clause 136, wherein the welding filler metal consumable is in the form a wire or strip having a flux cover.

Clause 139: The welding filler metal consumable of clause 136, wherein the welding filler metal consumable is in the form of a sheath having a flux core.

Clause 140: A welding deposit formed from the welding filler metal consumable of any one of clauses 136-139.

Clause 141: A method of making a weld deposit, comprising: providing a welding filler metal consumable of any one of clauses 136-139; and melting and cooling the welding filler metal consumable to create the weld deposit.

Clause 142: The method of making the weld deposit of clause 141, wherein the melting and cooling of the welding filler metal consumable is accomplished by gas metal arc welding (GMAW).

Clause 143: The method of making the weld deposit of clause 141, wherein the melting and cooling of the welding filler metal consumable is accomplished by gas tungsten arc welding (GTAW).

Clause 144: A weldment formed using the welding filler metal consumable of any one of clauses 136-139.

Clause 145: The weldment of clause 144, wherein the weldment includes at least two components connected by a weld deposit formed using the welding filler metal consumable.

Clause 146: The weldment of clause 145, wherein the at least two components include a first component having a first composition different from the welding filler metal consumable and a second component having a second composition different from the first composition and different from the welding filler metal consumable.

Clause 147: The weldment of clause 144, wherein the weldment includes a substrate having a weld deposit overlay formed thereon using the welding filler metal consumable.

Clause 148: The weldment of clause 147, wherein the substrate is a steel substrate.

Clause 149: The weldment of clause 144, wherein the weldment is in nuclear power generation equipment.

Clause 150: The weldment of clause 144, wherein the weldment is in the form of a tubesheet weld overlay, such as a tubesheet weld overlay of a steam generator of a nuclear reactor.

Clause 151: The weldment of clause 144, wherein the weldment is in the form of a structural weld overlay, such as a structural weld overlay on an underlying weld of a pressurizer nozzle of a nuclear reactor.

The present invention is neither limited to nor defined by the above clauses. Rather, reference should be made to the claims for which protection is sought with consideration of equivalents thereto.

In addition to the above, other features of the invention will be apparent from the detailed description and drawings.

### BRIEF DESCRIPTION OF THE DRAWINGS

In the drawings:

FIG. 1 shows an equilibrium weight fraction of austenite vs. temperature for an exemplary alloy as calculated from thermodynamic data, wherein the alloy contains 0.01 wt % carbon.

FIG. 2 shows an equilibrium austenite composition vs. amount of austenite formed in weight fraction for an exemplary alloy as calculated from thermodynamic data, wherein the alloy contains 0.01 wt % carbon.

FIG. 3 shows an equilibrium weight fraction of MC carbide vs. temperature for an exemplary alloy as calculated from thermodynamic data, wherein the alloy contains 0.01 wt % carbon.

FIG. 4 shows an equilibrium MC carbide composition vs. amount of MC carbide formed in weight fraction for an exemplary alloy as calculated from thermodynamic data, wherein the alloy contains 0.01 wt % carbon.

FIG. 5 shows an equilibrium weight fraction of laves phase vs. temperature for an exemplary alloy as calculated from thermodynamic data, wherein the alloy contains 0.01 wt % carbon.

FIG. 6 shows an equilibrium laves phase composition vs. amount of laves phase formed in weight fraction for an exemplary alloy as calculated from thermodynamic data, wherein the alloy contains 0.01 wt % carbon.

FIG. 7 shows an equilibrium liquid composition vs. amount of solid phases formed in weight fraction for an exemplary alloy as calculated from thermodynamic data, wherein the alloy contains 0.01 wt % carbon.

FIG. 8 shows an equilibrium weight fraction of austenite vs. temperature for an exemplary alloy as calculated from thermodynamic data, wherein the alloy contains 0.02 wt % carbon.

FIG. 9 shows an equilibrium austenite composition vs. amount of austenite formed in weight fraction for an exemplary alloy as calculated from thermodynamic data, wherein the alloy contains 0.02 wt % carbon.

FIG. 10 shows an equilibrium weight fraction of MC carbide vs. temperature for an exemplary alloy as calculated from thermodynamic data, wherein the alloy contains 0.02 wt % carbon.

FIG. 11 shows an equilibrium MC carbide composition vs. amount of MC carbide formed in weight fraction for an exemplary alloy as calculated from thermodynamic data, wherein the alloy contains 0.02 wt % carbon.

FIG. 12 shows an equilibrium weight fraction of laves phase vs. temperature for an exemplary alloy as calculated from thermodynamic data, wherein the alloy contains 0.02 wt % carbon.

FIG. 13 shows an equilibrium laves phase composition vs. amount of laves phase formed in weight fraction for an exemplary alloy as calculated from thermodynamic data, wherein the alloy contains 0.02 wt % carbon.

FIG. 14 shows an equilibrium liquid composition vs. amount of solid phases formed in weight fraction for an exemplary alloy as calculated from thermodynamic data, wherein the alloy contains 0.02 wt % carbon.

FIG. 15 shows an equilibrium weight fraction of austenite vs. temperature for an exemplary alloy as calculated from thermodynamic data, wherein the alloy contains 0.03 wt % carbon.

FIG. 16 shows an equilibrium austenite composition vs. amount of austenite formed in weight fraction for an exemplary alloy as calculated from thermodynamic data, wherein the alloy contains 0.03 wt % carbon.

FIG. 17 shows an equilibrium weight fraction of MC carbide vs. temperature for an exemplary alloy as calculated from thermodynamic data, wherein the alloy contains 0.03 wt % carbon.

FIG. 18 shows an equilibrium MC carbide composition vs. amount of MC carbide formed in weight fraction for an exemplary alloy as calculated from thermodynamic data, wherein the alloy contains 0.03 wt % carbon.

FIG. 19 shows an equilibrium weight fraction of laves phase vs. temperature for an exemplary alloy as calculated from thermodynamic data, wherein the alloy contains 0.03 wt % carbon.

FIG. 20 shows an equilibrium laves phase composition vs. amount of laves phase formed in weight fraction for an exemplary alloy as calculated from thermodynamic data, wherein the alloy contains 0.03 wt % carbon.

FIG. 21 shows an equilibrium liquid composition vs. amount of solid phases formed in weight fraction for an exemplary alloy as calculated from thermodynamic data, wherein the alloy contains 0.03 wt % carbon.

FIG. 22 shows an equilibrium weight fraction of austenite vs. temperature for an exemplary alloy as calculated from thermodynamic data, wherein the alloy contains 0.04 wt % carbon.

FIG. 23 shows an equilibrium austenite composition vs. amount of austenite formed in weight fraction for an exemplary alloy as calculated from thermodynamic data, wherein the alloy contains 0.04 wt % carbon.

FIG. 24 shows an equilibrium weight fraction of MC carbide vs. temperature for an exemplary alloy as calculated from thermodynamic data, wherein the alloy contains 0.04 wt % carbon.

FIG. 25 shows an equilibrium MC carbide composition vs. amount of MC carbide formed in weight fraction for an exemplary alloy as calculated from thermodynamic data, wherein the alloy contains 0.04 wt % carbon.

FIG. 26 shows an equilibrium weight fraction of laves phase vs. temperature for an exemplary alloy as calculated from thermodynamic data, wherein the alloy contains 0.04 wt % carbon.

FIG. 27 shows an equilibrium laves phase composition vs. amount of laves phase formed in weight fraction for an exemplary alloy as calculated from thermodynamic data, wherein the alloy contains 0.04 wt % carbon.

FIG. 28 shows an equilibrium liquid composition vs. amount of solid phases formed in weight fraction for an exemplary alloy as calculated from thermodynamic data, wherein the alloy contains 0.04 wt % carbon.

FIG. 29 shows an equilibrium weight fraction of austenite vs. temperature for an exemplary alloy as calculated from thermodynamic data, wherein the alloy contains 0.05 wt % carbon.

FIG. 30 shows an equilibrium austenite composition vs. amount of austenite formed in weight fraction for an exemplary alloy as calculated from thermodynamic data, wherein the alloy contains 0.05 wt % carbon.

FIG. 31 shows an equilibrium weight fraction of MC carbide vs. temperature for an exemplary alloy as calculated from thermodynamic data, wherein the alloy contains 0.05 wt % carbon.

FIG. 32 shows an equilibrium MC carbide composition vs. amount of MC carbide formed in weight fraction for an exemplary alloy as calculated from thermodynamic data, wherein the alloy contains 0.05 wt % carbon.

FIG. 33 shows an equilibrium weight fraction of laves phase vs. temperature for an exemplary alloy as calculated from thermodynamic data, wherein the alloy contains 0.05 wt % carbon.

FIG. 34 shows an equilibrium laves phase composition vs. amount of laves phase formed in weight fraction for an exemplary alloy as calculated from thermodynamic data, wherein the alloy contains 0.05 wt % carbon.

FIG. 35 shows an equilibrium liquid composition vs. amount of solid phases formed in weight fraction for an exemplary alloy as calculated from thermodynamic data, wherein the alloy contains 0.05 wt % carbon.

FIG. 36 shows an equilibrium weight fraction of austenite vs. temperature for an exemplary alloy as calculated from thermodynamic data, wherein the alloy contains 0.06 wt % carbon.

FIG. 37 shows an equilibrium austenite composition vs. amount of austenite formed in weight fraction for an exemplary alloy as calculated from thermodynamic data, wherein the alloy contains 0.06 wt % carbon.

FIG. 38 shows an equilibrium weight fraction of MC carbide vs. temperature for an exemplary alloy as calculated from thermodynamic data, wherein the alloy contains 0.06 wt % carbon.

FIG. 39 shows an equilibrium MC carbide composition vs. amount of MC carbide formed in weight fraction for an exemplary alloy as calculated from thermodynamic data, wherein the alloy contains 0.06 wt % carbon.

FIG. 40 shows an equilibrium weight fraction of laves phase vs. temperature for an exemplary alloy as calculated from thermodynamic data, wherein the alloy contains 0.06 wt % carbon.

FIG. 41 shows an equilibrium laves phase composition vs. amount of laves phase formed in weight fraction for an exemplary alloy as calculated from thermodynamic data, wherein the alloy contains 0.06 wt % carbon.

FIG. 42 shows an equilibrium liquid composition vs. amount of solid phases formed in weight fraction for an exemplary alloy as calculated from thermodynamic data, wherein the alloy contains 0.06 wt % carbon.

FIG. 43 shows an equilibrium weight fraction of austenite vs. temperature for an exemplary alloy as calculated from thermodynamic data, wherein the alloy contains 0.07 wt % carbon.

FIG. 44 shows an equilibrium austenite composition vs. amount of austenite formed in weight fraction for an exemplary alloy as calculated from thermodynamic data, wherein the alloy contains 0.07 wt % carbon.

FIG. 45 shows an equilibrium weight fraction of MC carbide vs. temperature for an exemplary alloy as calculated from thermodynamic data, wherein the alloy contains 0.07 wt % carbon.

FIG. 46 shows an equilibrium MC carbide composition vs. amount of MC carbide formed in weight fraction for an exemplary alloy as calculated from thermodynamic data, wherein the alloy contains 0.07 wt % carbon.

FIG. 47 shows an equilibrium liquid composition vs. amount of solid phases formed in weight fraction for an exemplary alloy as calculated from thermodynamic data, wherein the alloy contains 0.07 wt % carbon.

FIGS. 48 and 49 show SEM micrographs of a comparative heat of 52MSS.

FIGS. 50 and 51 show SEM micrographs of an exemplary heat of HV1779.

FIG. 52 shows EDS results taken at a surface a micrograph shown in FIG. 53 of an exemplary heat of HV1779.

FIG. 53 shows a surface of a micrograph of an exemplary heat of HV1779 at which EDS results of FIG. 52 were taken.

### DESCRIPTION OF THE INVENTION

Unless otherwise indicated, each numerical parameter in the specification and claims should be construed in light of the number of reported significant digits and by applying ordinary rounding techniques.

Also, it should be understood that any numerical range recited herein is intended to include all sub-ranges subsumed therein. For example, a range of “1 to 10” is intended to include all sub-ranges between the recited minimum value of 1 and the recited maximum value of 10.

All compositions are given in weight percent unless specifically stated otherwise.

A welding filler metal is provided. In its broadest composition, the welding filler metal comprises, by weight percent: chromium of at least 28.0% and at most 31.5%; niobium of at least 0.60%; tantalum of at least 0.010%; molybdenum of at least 1.0% and at most 7.0%; carbon of at least 0.040% and at most 0.09%; manganese of at most 1.0%; balance nickel and inevitable impurities, wherein the sum of niobium and tantalum is at least 2.2% and at most 4.0%.

Although the invention is not limited by theory, a description of the effect of alloying elements as is understood by the present inventors is provided as follows.

Chromium (Cr)—

Chromium is a mandatory element of the welding filler metal and is beneficial for contributing to primary water stress corrosion cracking (PWSCC) resistance. Stress corrosion cracking (SCC) is the growth of a crack formation in a corrosive environment that can lead to sudden failures of materials subjected to tensile stresses during use, and primary water stress corrosion cracking (PWSCC) is a name given to intergranular stress corrosion cracking of nickel base alloys, in particular weld metals, in primary water conditions in nuclear applications. High amounts of chromium in solid solution are beneficial for contributing to primary water stress corrosion cracking (PWSCC) resistance of a weld deposit. Accordingly, the chromium content is controlled to be at least 28.0%, preferably at least 28.5%, more preferably at least 29.0%, more preferably at least 29.5%, and more preferably at least 30.0%.

However, excessive amounts of chromium have a detrimental effect on hot workability. Accordingly, the chromium content is controlled to be at most 31.5%, and preferably at most 31.0%.

Niobium (Nb) and Tantalum (Ta)—

In the presence of carbon and molybdenum, niobium is beneficial for forming MC carbides that improve ductility-dip cracking (DDC). Ductility-dip cracking (DDC) is an intergranular cracking phenomenon that occurs during high temperature processing, such as welding. Accordingly, the niobium content is controlled to be at least 0.60%, and preferably at least 0.70%.

However, excessive amounts of niobium have a detrimental effect on contributing to the formation of laves phase. Accordingly, the niobium content is controlled to be at most 3.9%, preferably at most 3.0%, more preferably at most 2.3%, more preferably at most 1.5%, more preferably at most 1.0%, and more preferably at most 0.8%.

Like niobium, tantalum in the presence of carbon and molybdenum is beneficial for forming MC carbides that improve resistance to ductility-dip cracking (DDC). Additionally, there are indications that tantalum reduces the formation of laves phase, thereby also improving hot cracking resistance. Accordingly, the tantalum content is controlled to be at least 0.010%, preferably at least 0.10%, more preferably at least 0.50%, more preferably at least 1.0%, and more preferably at least 1.5%.

To achieve the beneficial effect of forming MC carbides that improve resistance to ductility-dip cracking (DDC), the total weight percent of niobium and tantalum is controlled to be at least 2.2%. However, excessive amounts of niobium and tantalum have a detrimental effect on contributing to the formation of laves phase. Accordingly, the total weight percent of niobium and tantalum is controlled to be at most 4.0%, preferably at most 3.5%, more preferably at most 3.0%, more preferably at most 2.7%, and more preferably at most 2.4%.

Molybdenum (Mo)—

Molybdenum, in the presence of carbon, niobium, and tantalum, promotes the formation of MC carbides at high temperatures in a favorable morphology and in a favorable amount of carbides widely dispersed throughout the microstructure. The formation of MC carbides at high temperatures has the beneficial effect of pinning the grain boundaries of the matrix to promote the formation of serpentine grain boundaries that contribute to outstanding resistance to DCC. Accordingly, the molybdenum content is controlled to be at least 1.0%, preferably at least 1.5%, more preferably at least 2.0%, more preferably at least 2.6%, and more preferably at least 3.1%.

However, excessive amounts of molybdenum have a detrimental effect on the solubility limits of other elements and promote formation of unwanted secondary phases. Accordingly, the molybdenum content is controlled to be at most 7.0%, preferably at most 6.0%, more preferably at most 5.0%, more preferably at most 4.0%, and more preferably at most 3.3%.

Carbon (C)—

As explained above, niobium and tantalum in the presence of carbon and molybdenum are beneficial for forming beneficial MC carbides that provide good strength and ductility of grain boundaries. This effect can be accomplished with low levels of carbon.

However, low levels of carbon have been found to contribute to the detrimental formation of laves phase. Laves phases form during solidification of Ni—Cr—Mo—Ta—Nb welding filler metals because slow diffusing elements of the composition have a tendency to segregate between the solidifying matrix phase and the liquid phase of the weld pool. Niobium and tantalum, in particular, have a pronounced tendency to segregate between the solidifying matrix phase and the liquid phase, thereby enriching interdendritic liquid regions with niobium and tantalum. The high contents of niobium and tantalum in the interdendritic liquid regions tend to promote the formation of metastable laves phases. In other words, with low levels of carbon in the interdendritic regions, excess laves phases are formed as the solidification process proceeds down the gamma/NbC line of the phase diagram toward the eutectic termination of NbC+laves. The presence of these low-melting temperature laves phases creates problems of hot-cracking because shrinkage stresses occur during the final stages of solidification and the laves phase that remains liquid during partial solidification cannot sustain the tensile load imposed by the shrinkage stresses. This results in hot tears adjacent to the liquid laves phases.

To avoid this phenomenon, a higher carbon content is maintained in the welding filler metal. By adding additional carbon beyond what is needed for resistance to DCC, the liquid regions are enriched in carbon to promote the formation of more MC carbides within the Nb- and Ta-enriched interdendritic regions. Because the liquid is so enriched in carbon, the solidification process proceeds down the gamma/NbC line of the phase diagram and intersects the eutectic line at a high temperature. As a result, MC carbides begin to form in the liquid a short distance from the dendrite tips. Because of this redistribution of carbon and niobium and/or tantalum into the MC carbides, the remaining liquid is consumed along the gamma(liquid)/eutectic line before it reaches the gamma/laves/NbC intersection, and, thus, the formation of detrimental amounts of laves phase is avoided.

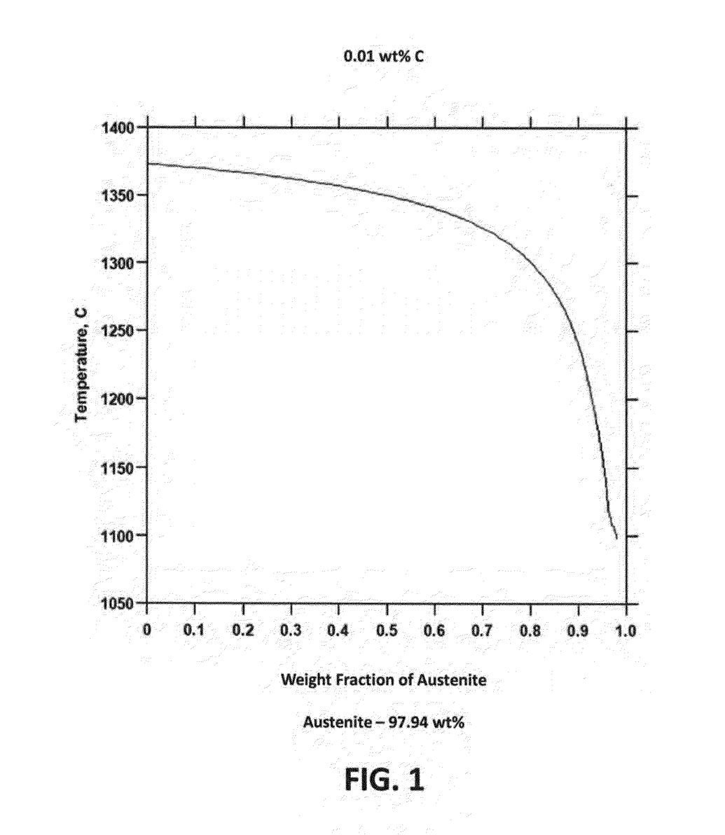

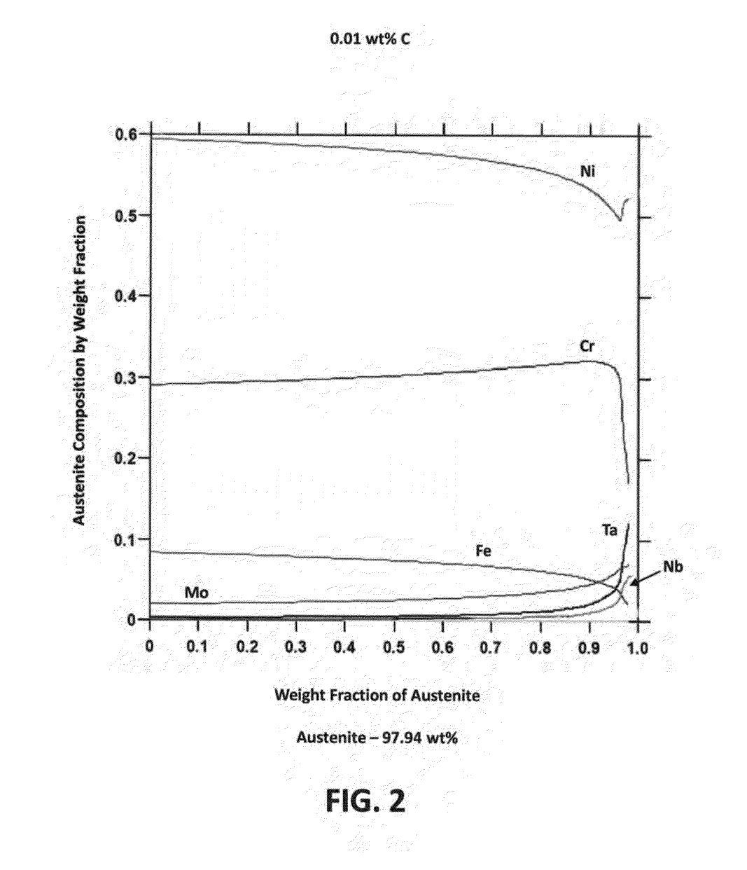

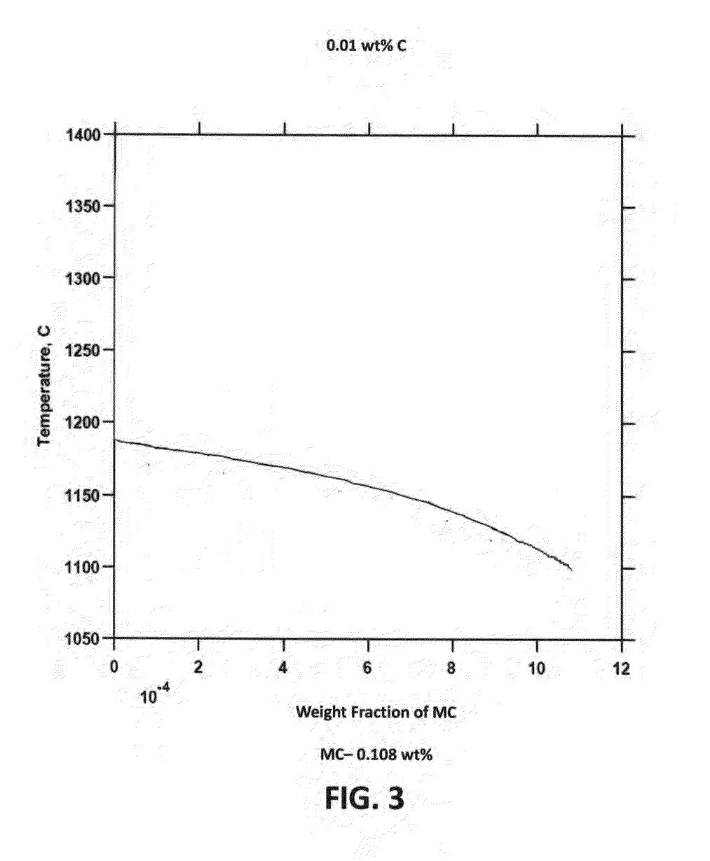

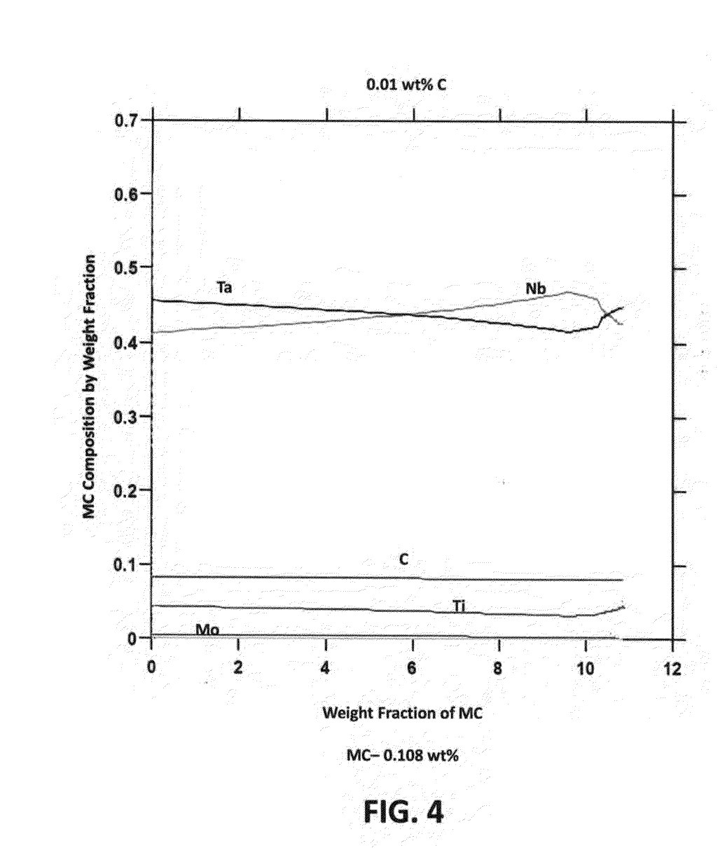

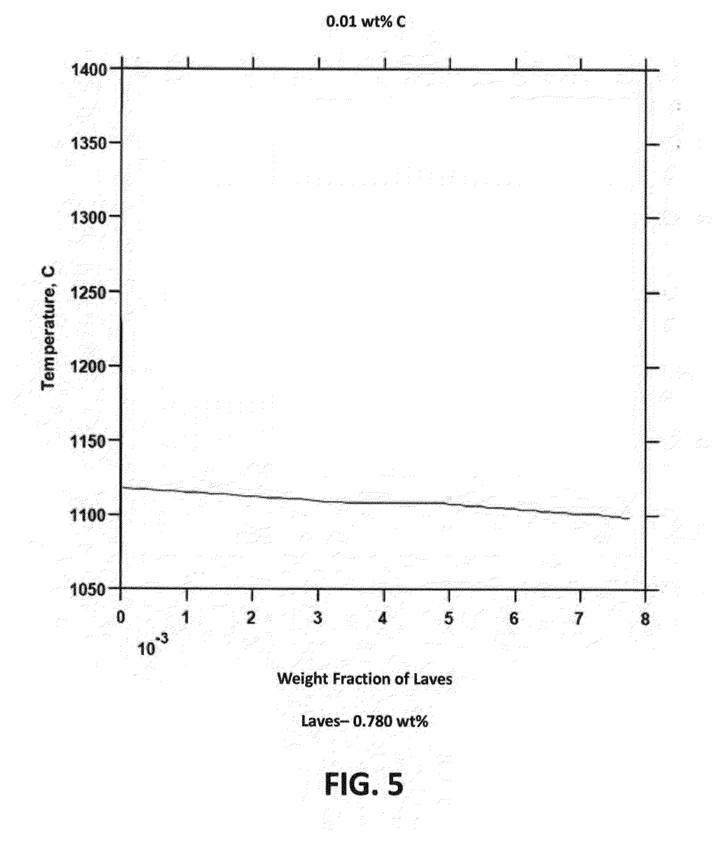

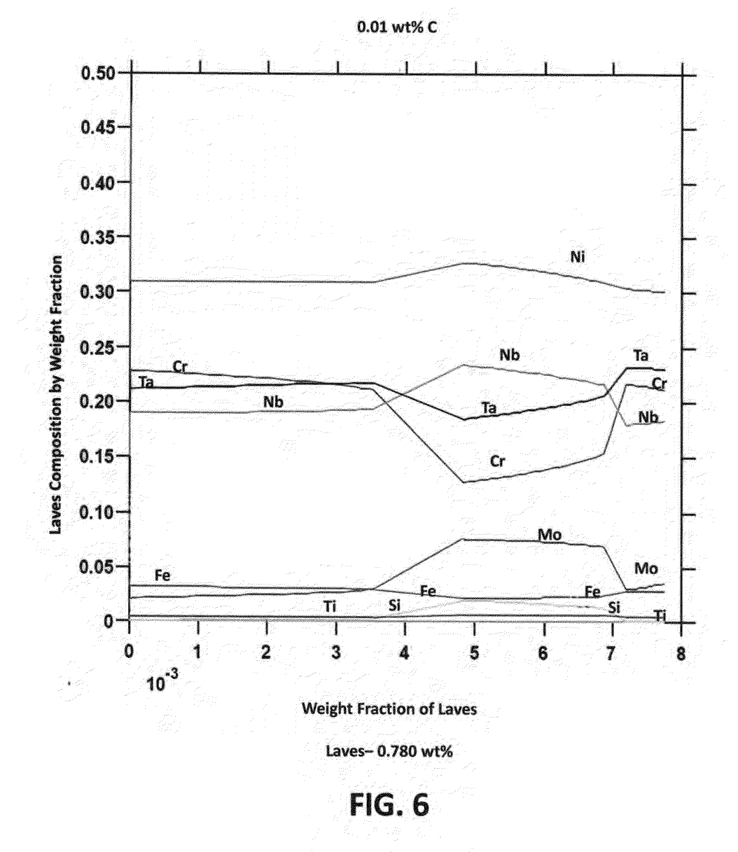

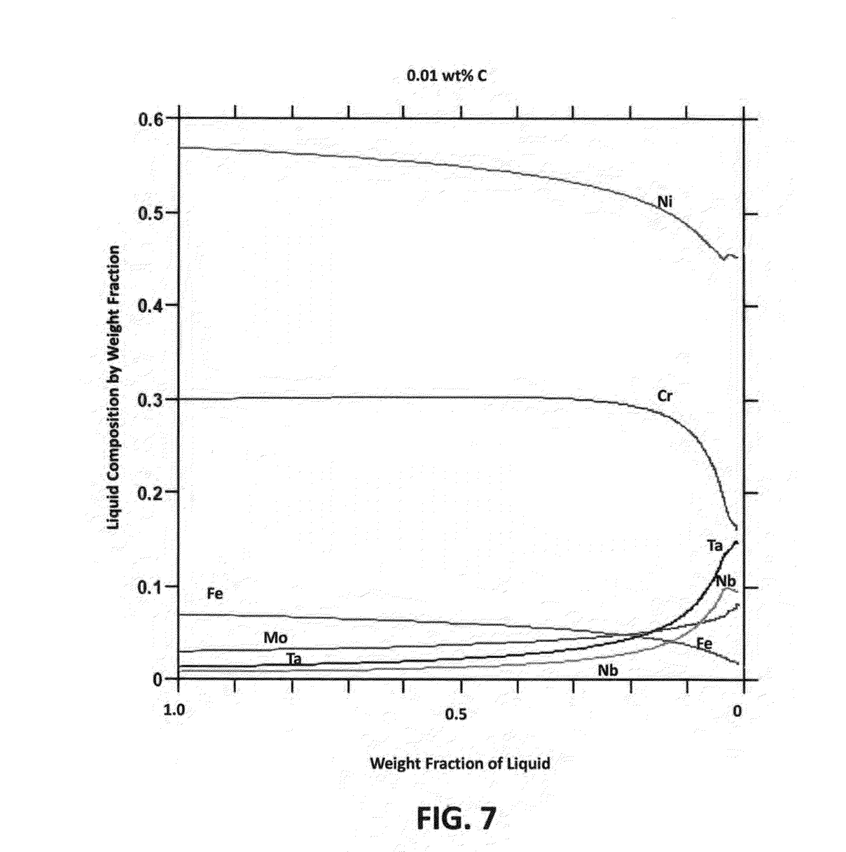

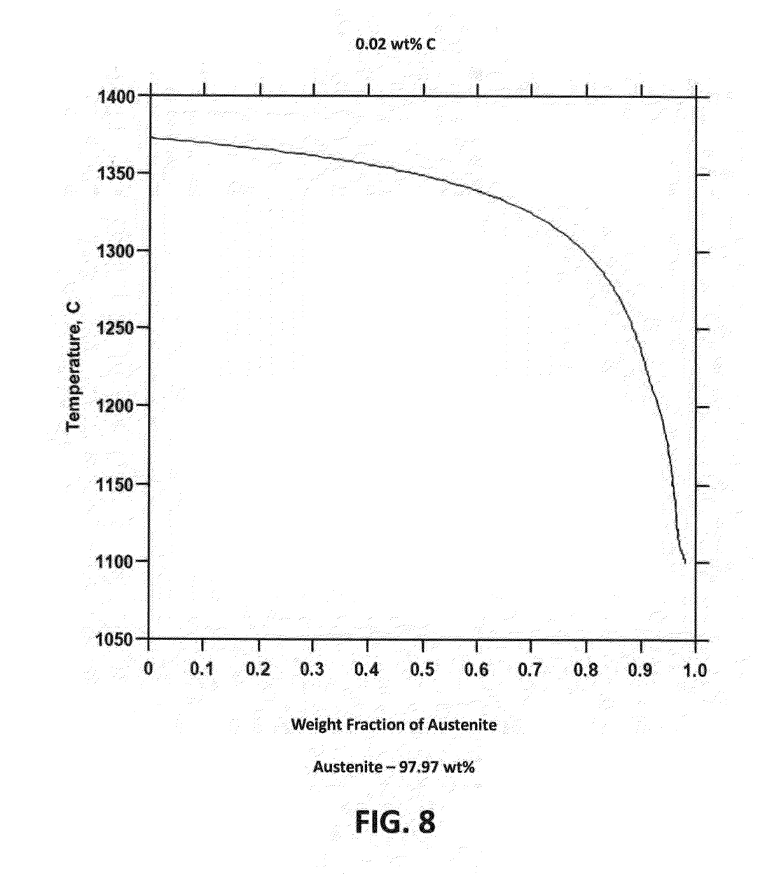

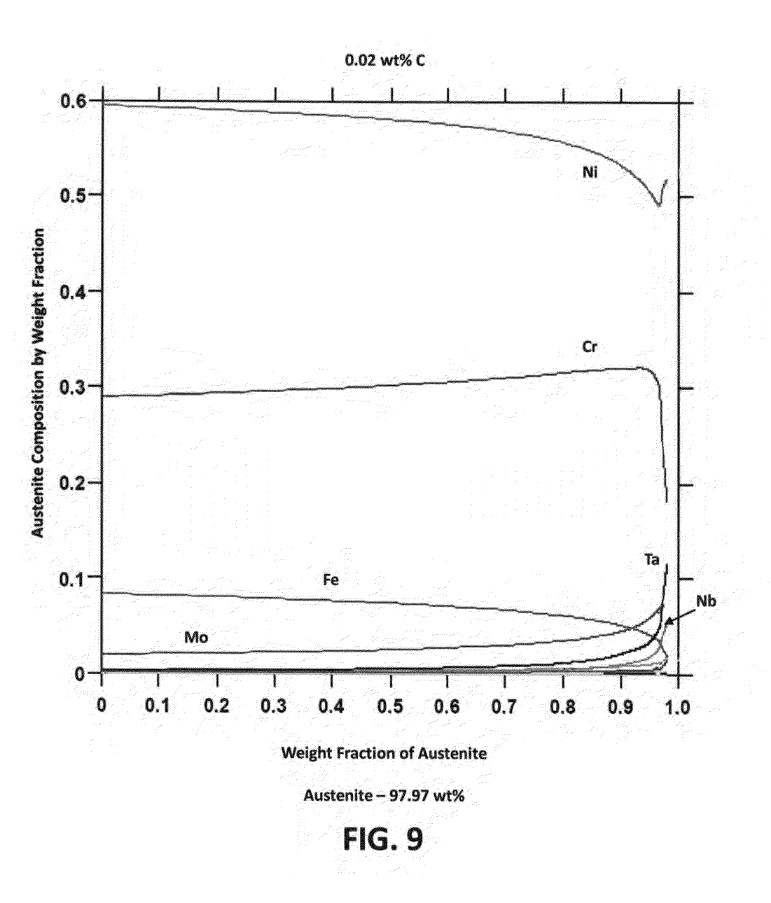

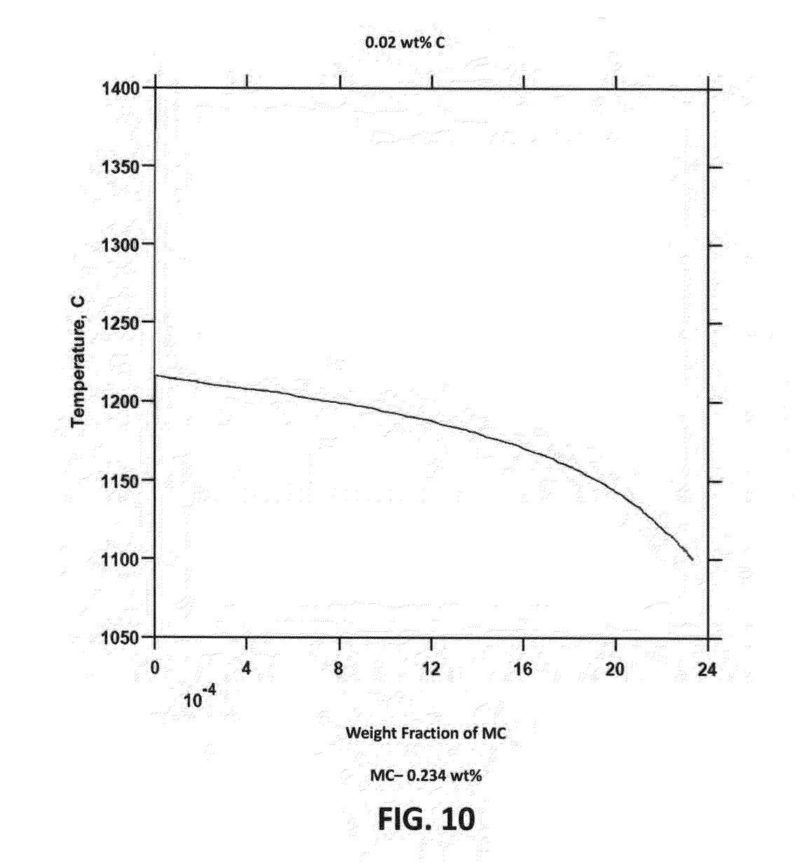

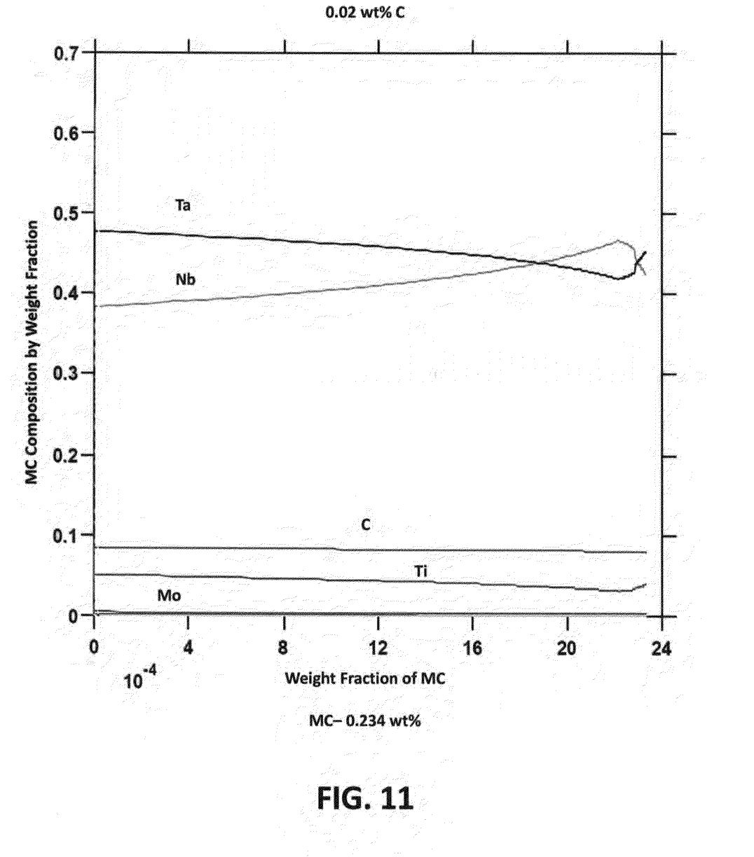

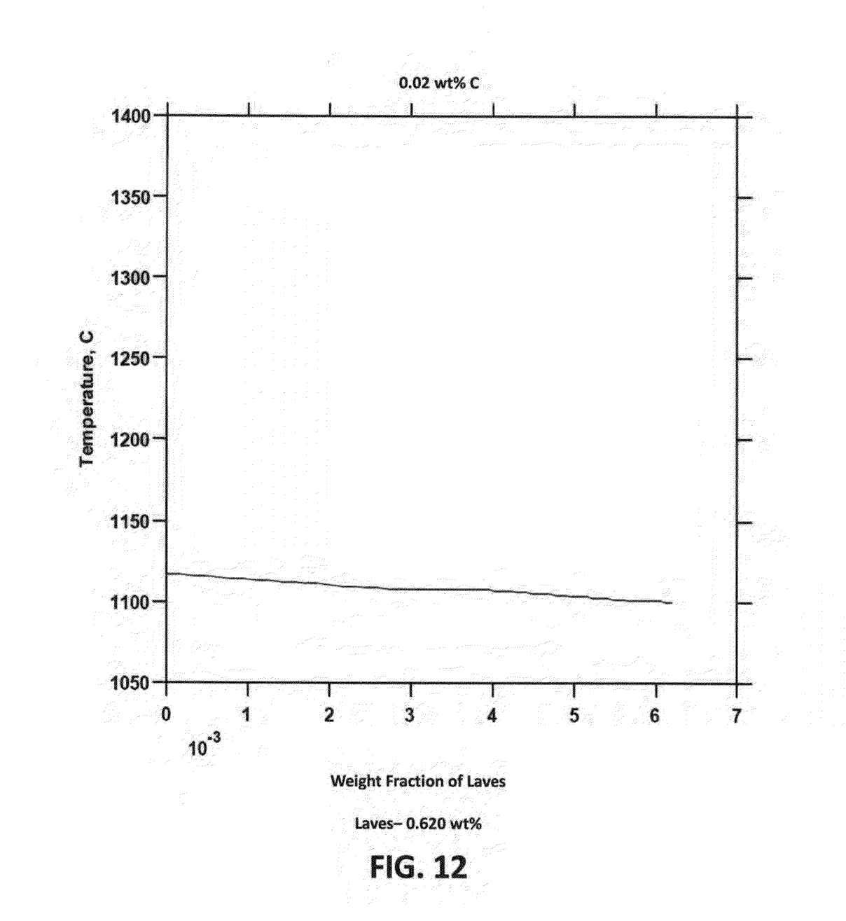

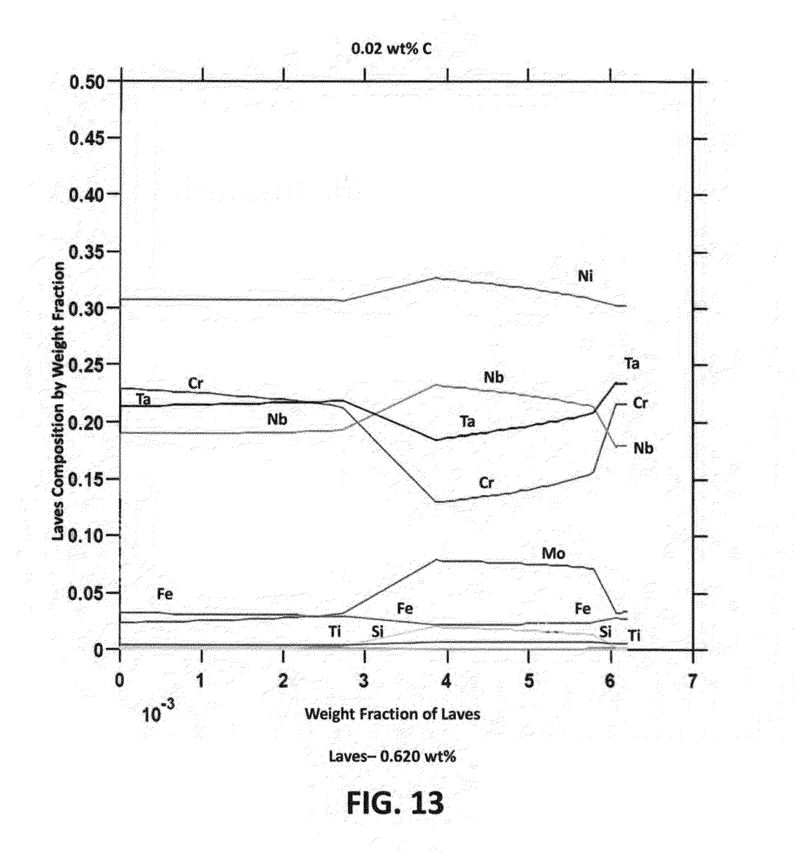

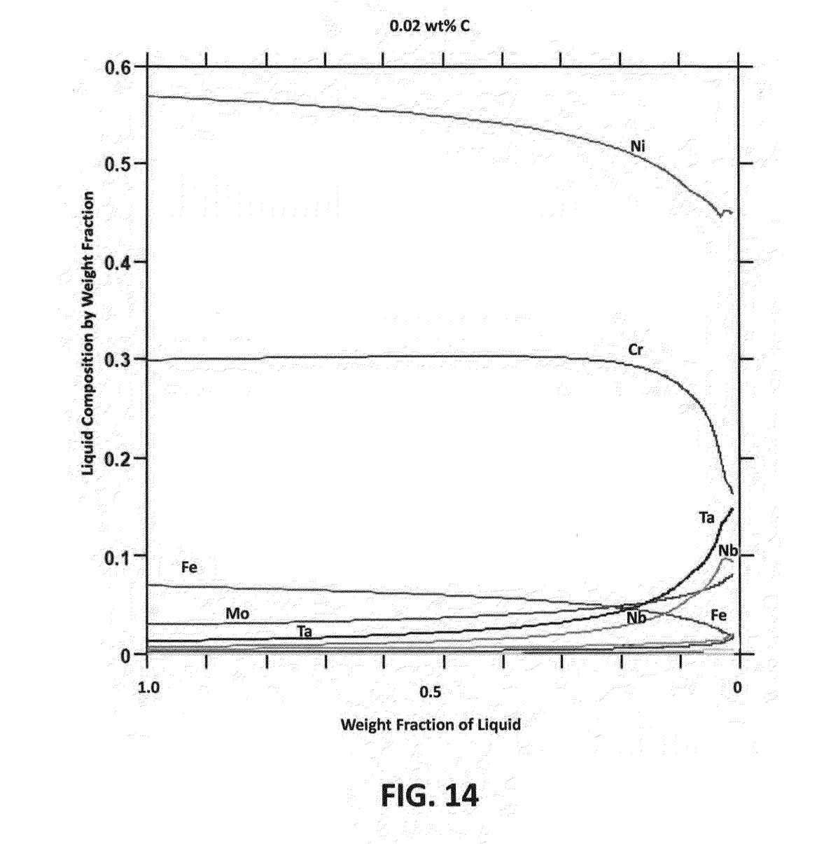

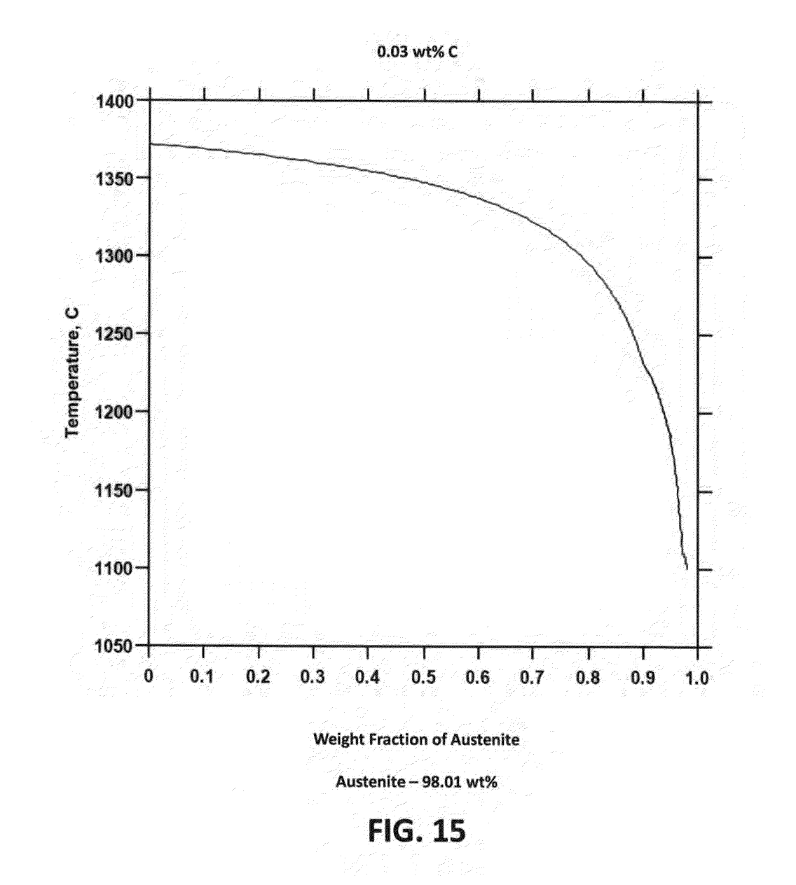

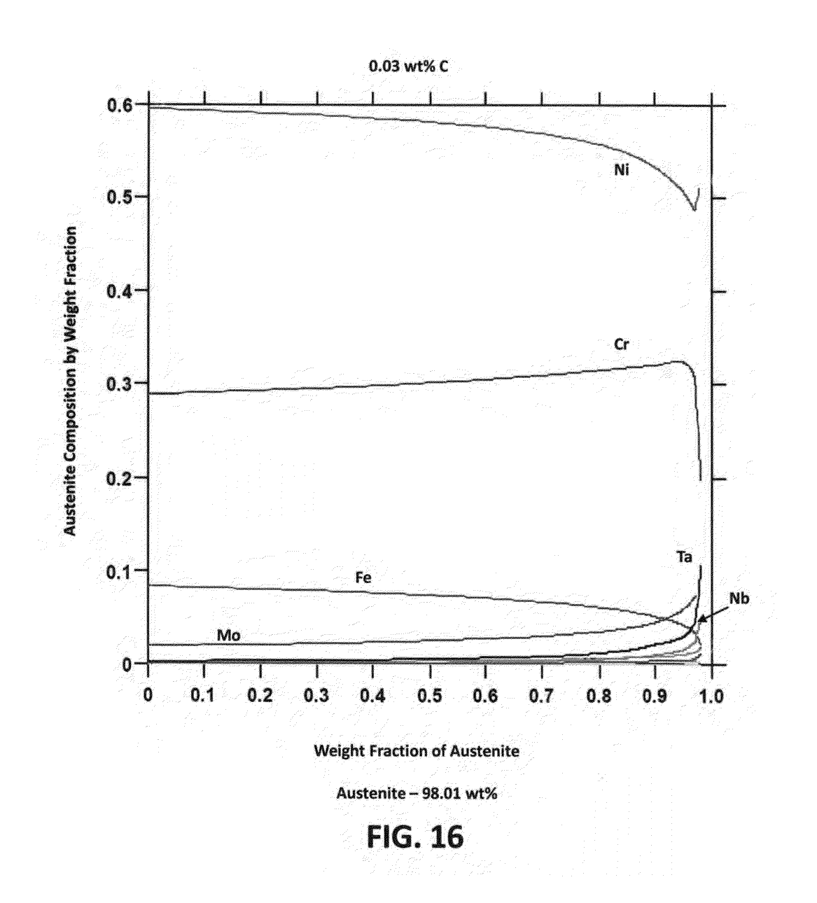

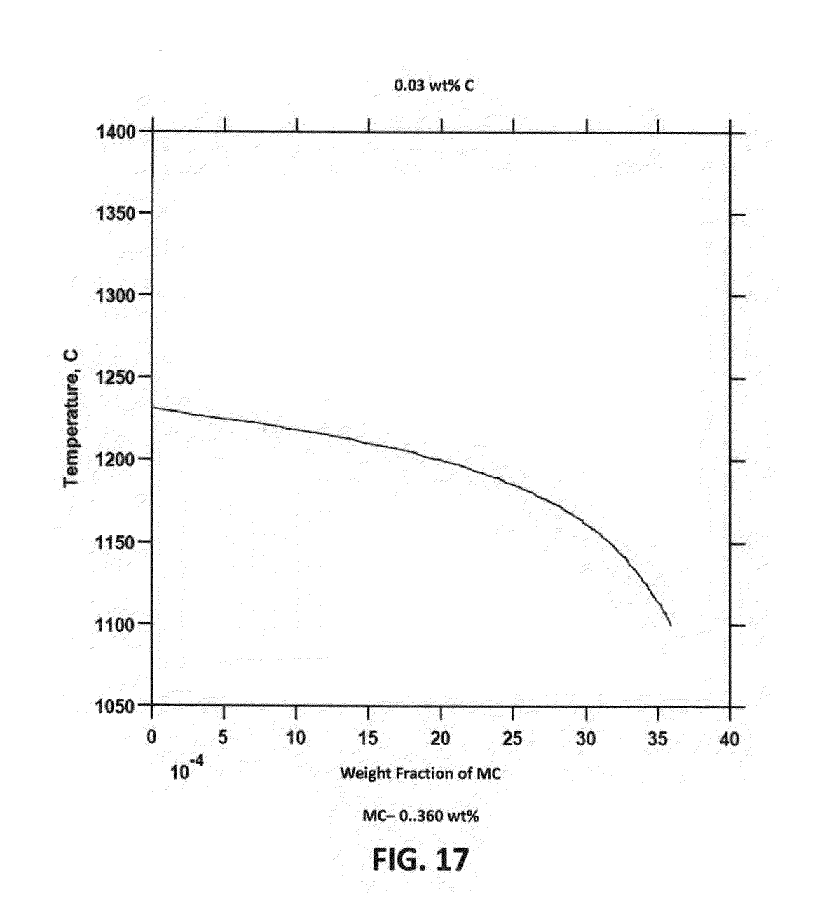

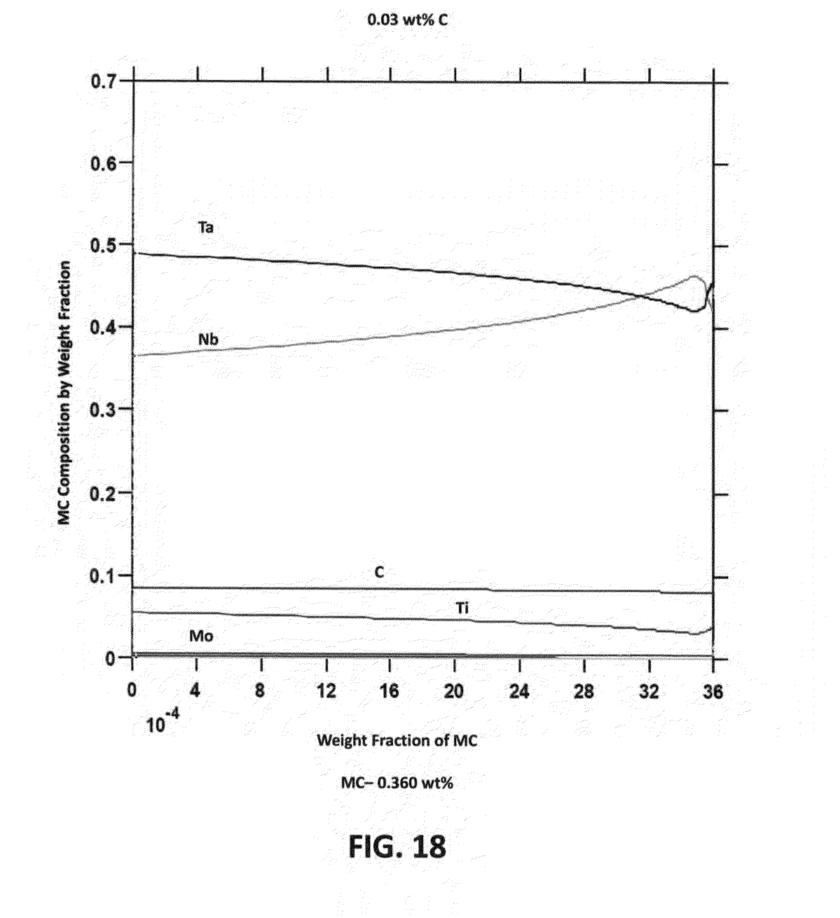

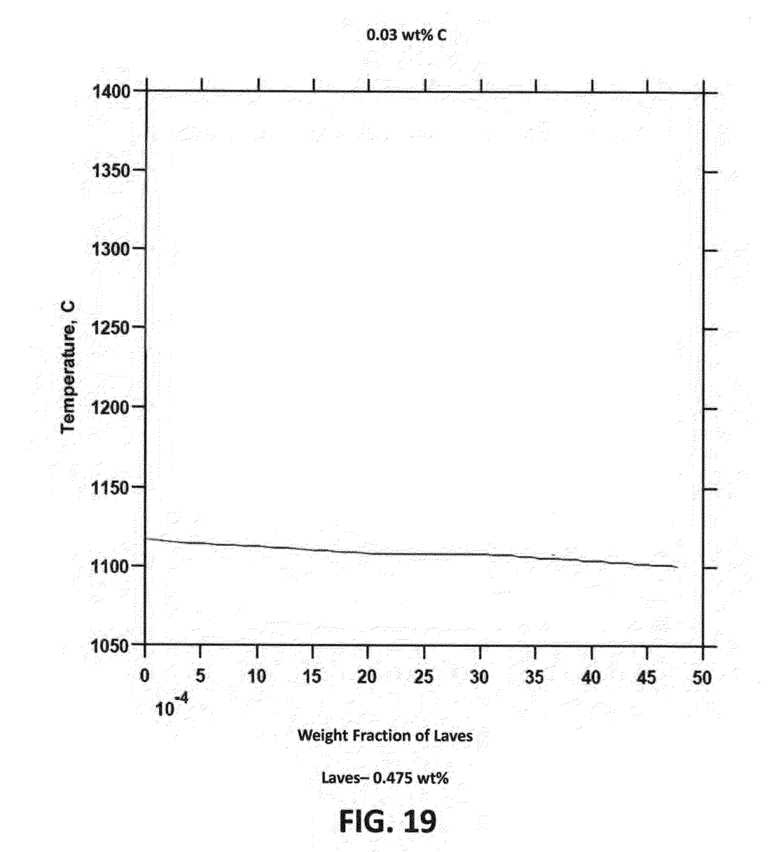

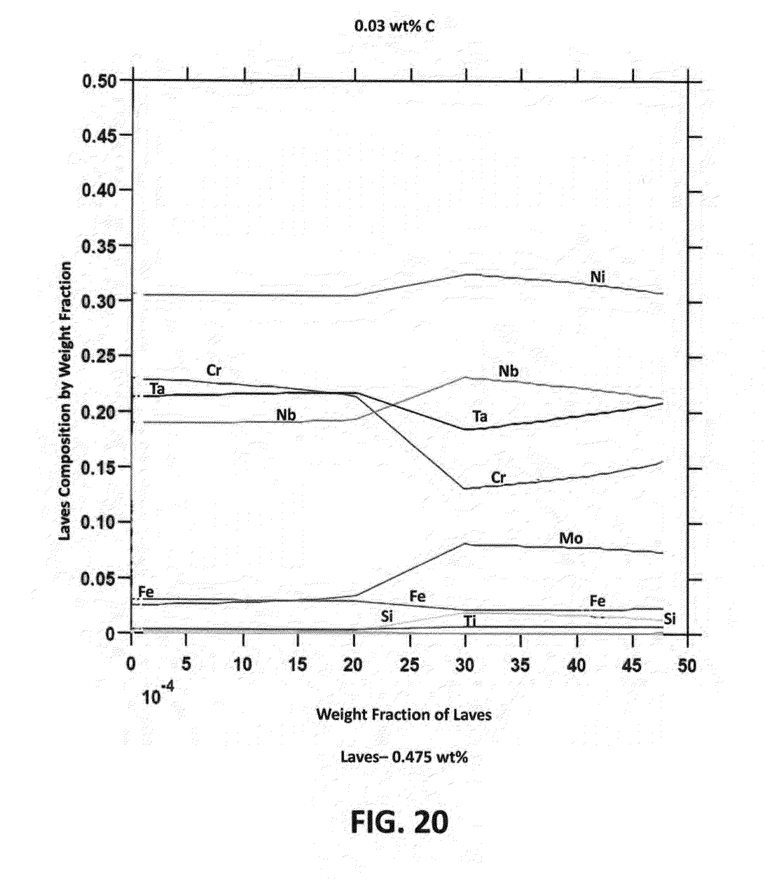

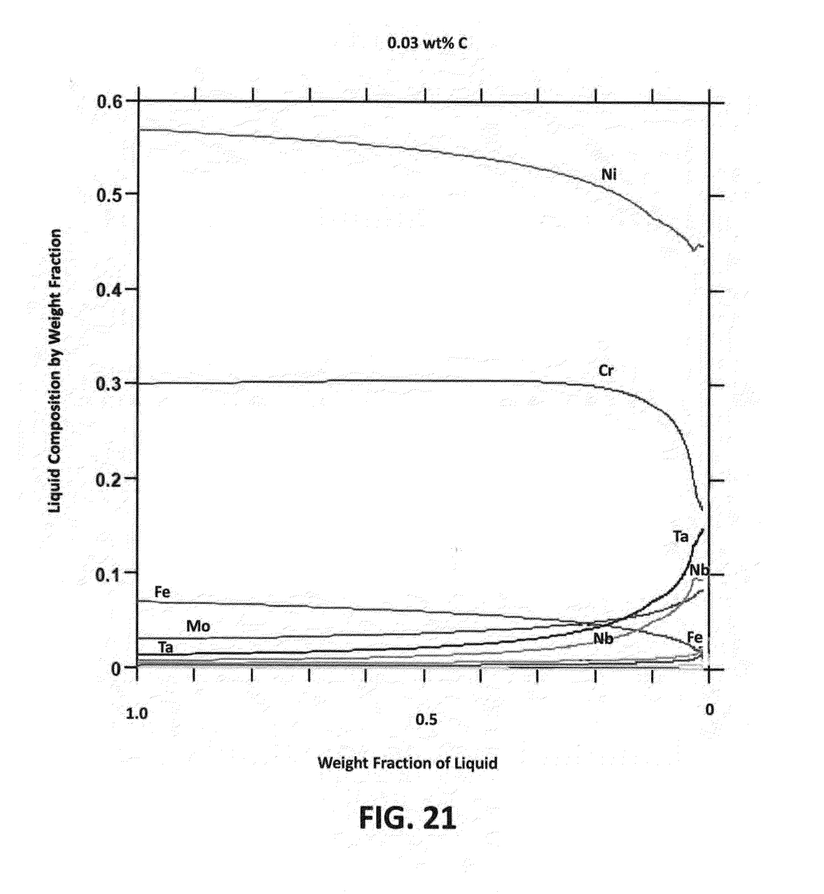

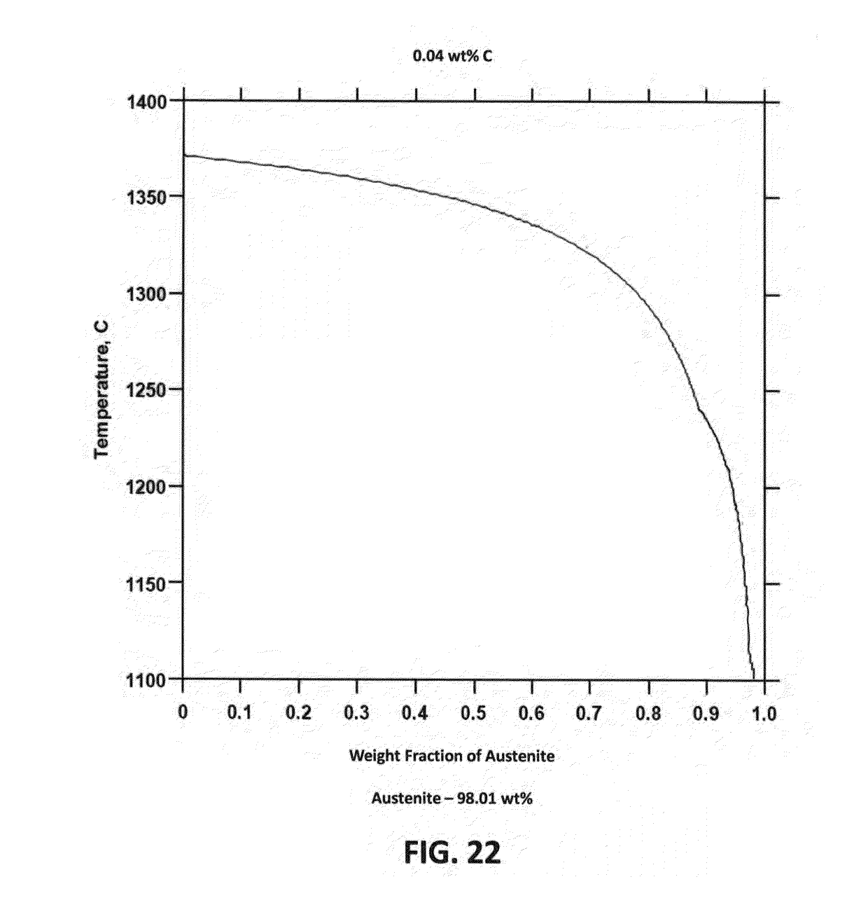

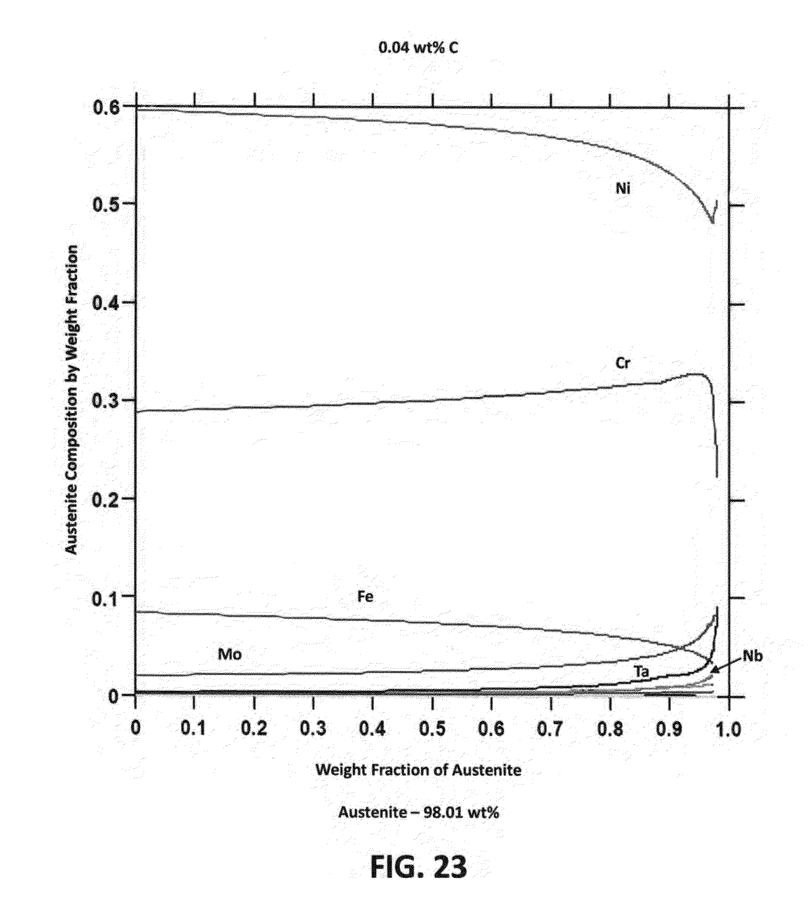

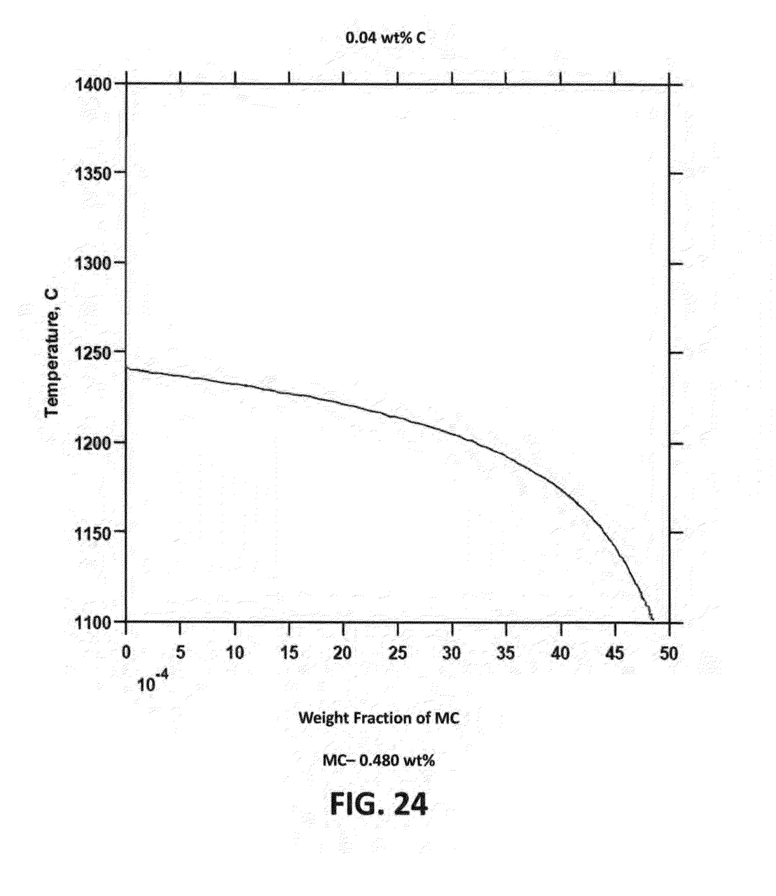

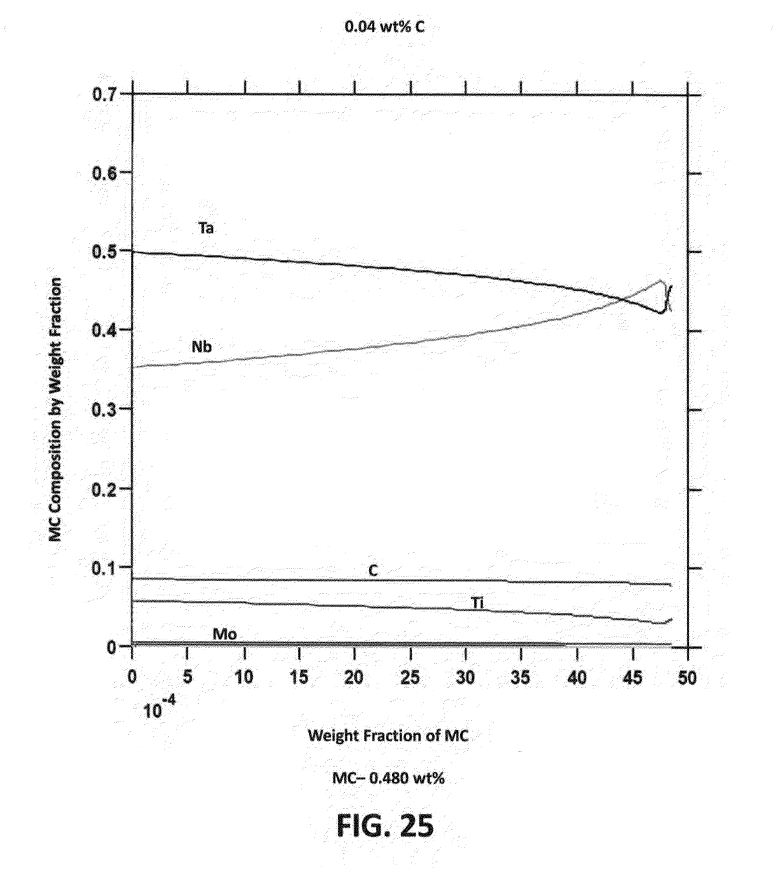

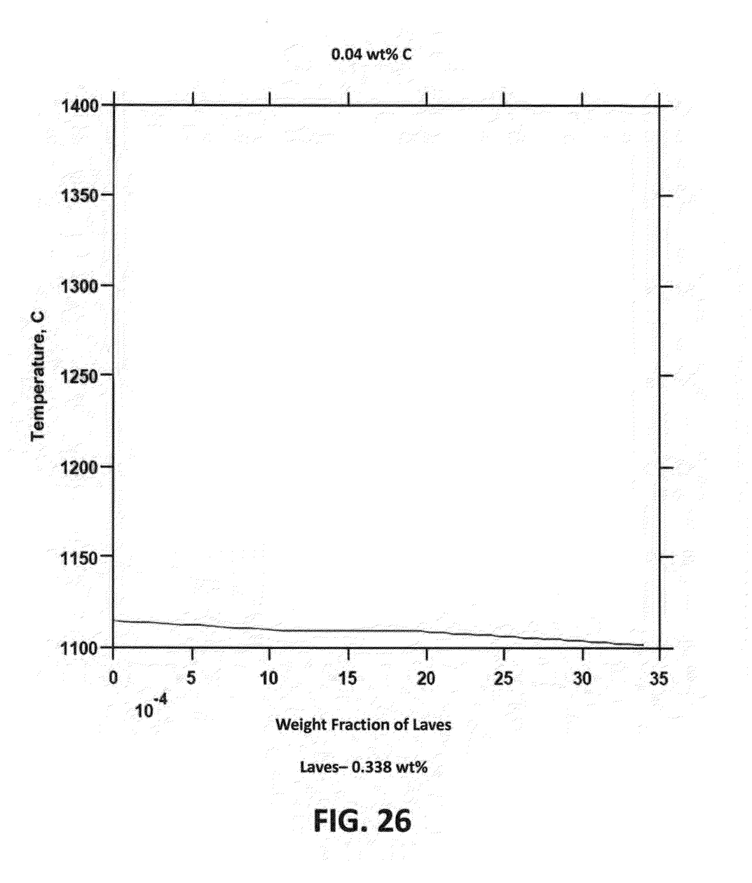

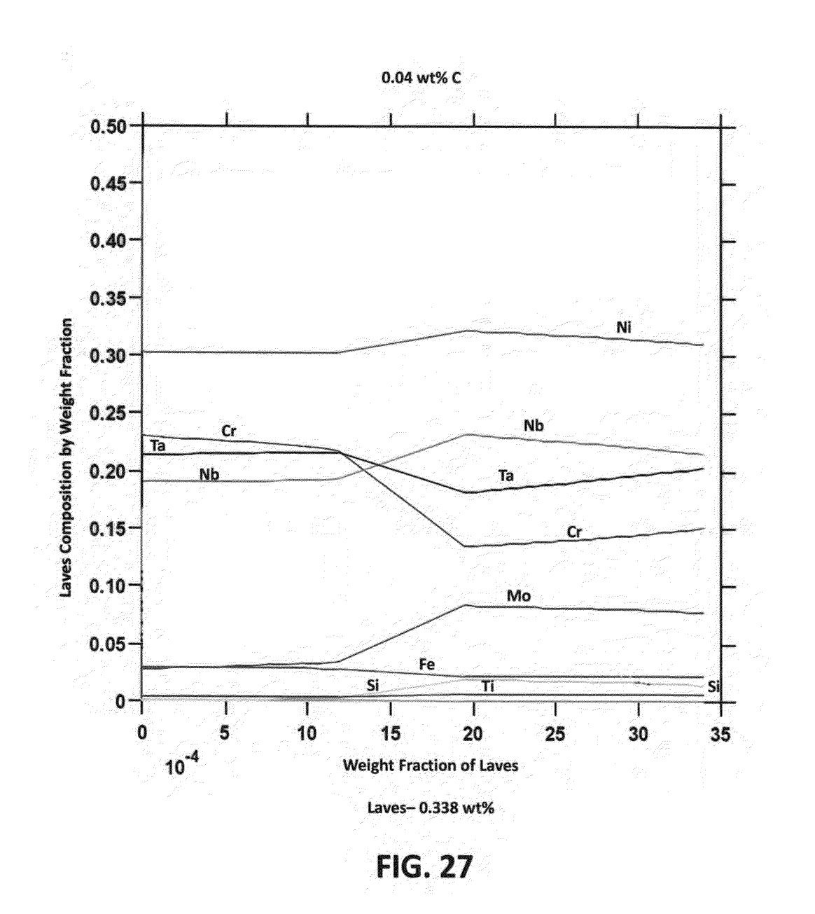

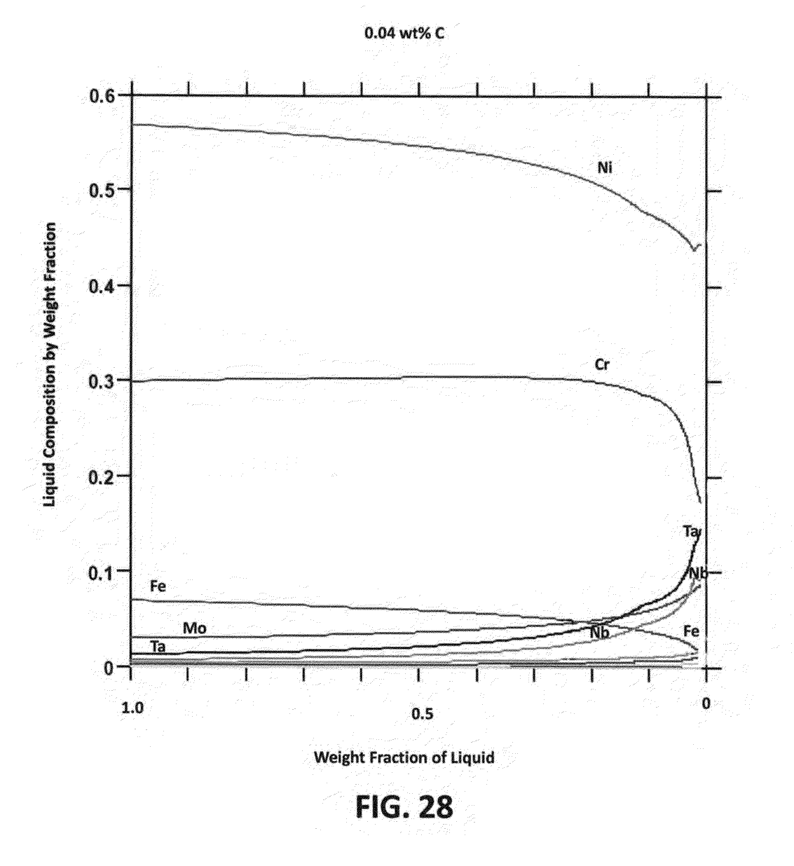

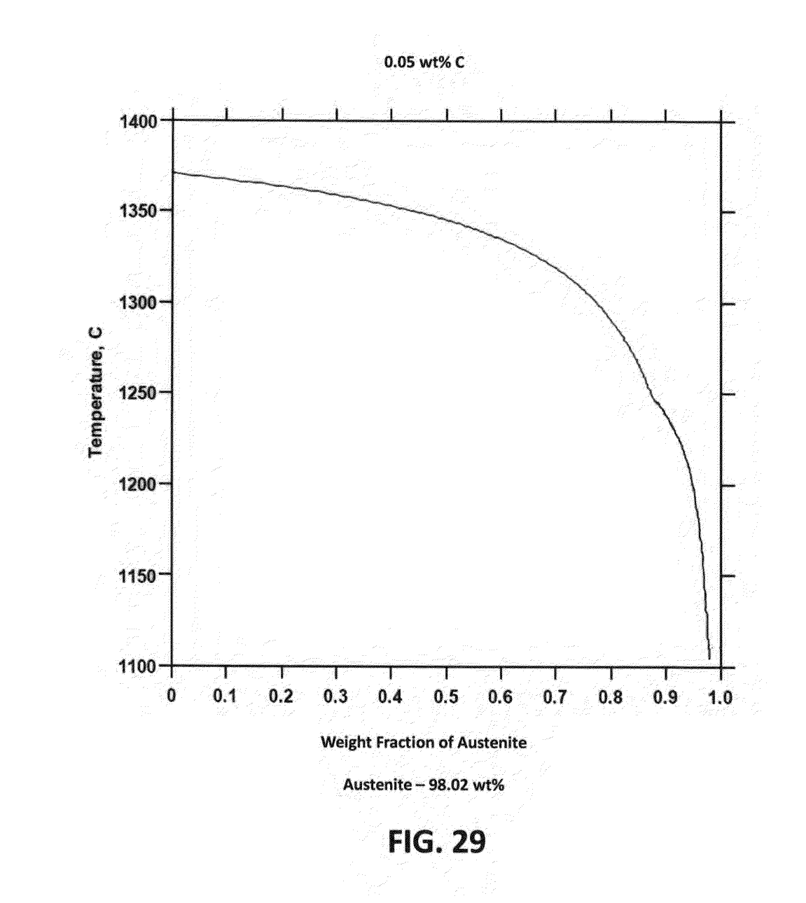

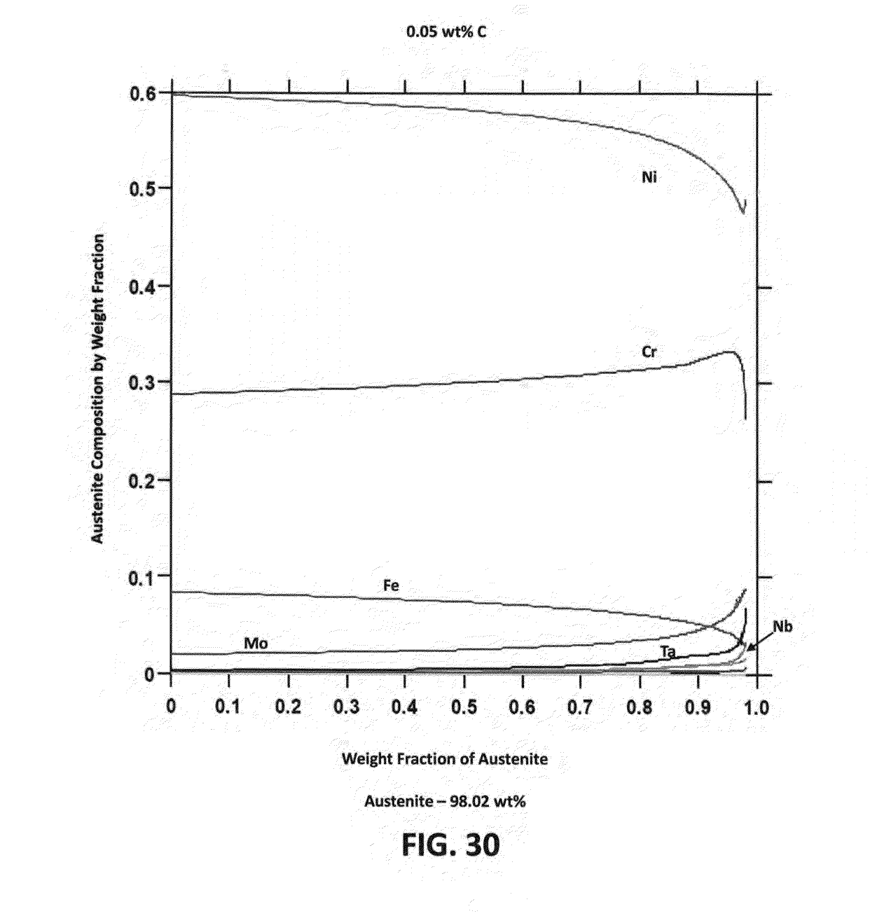

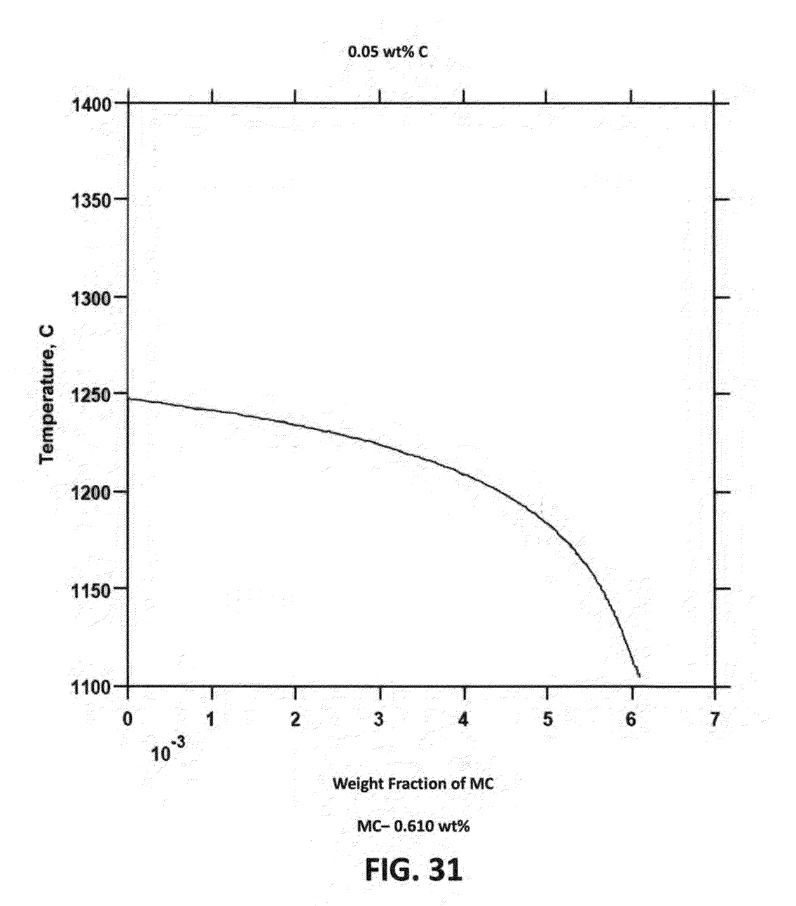

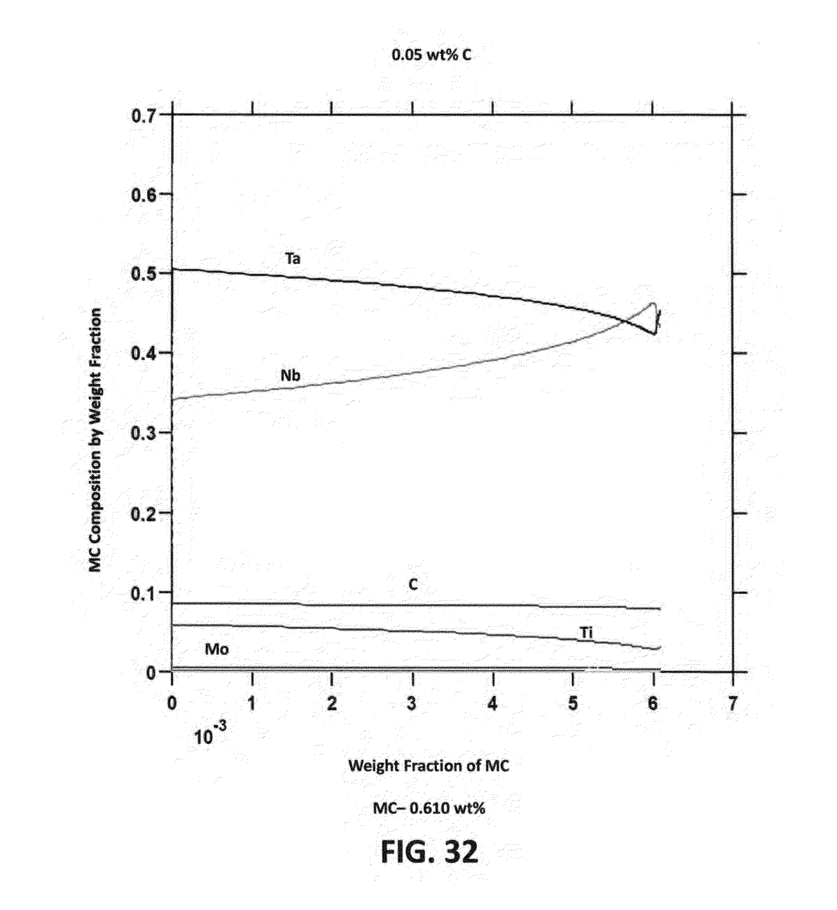

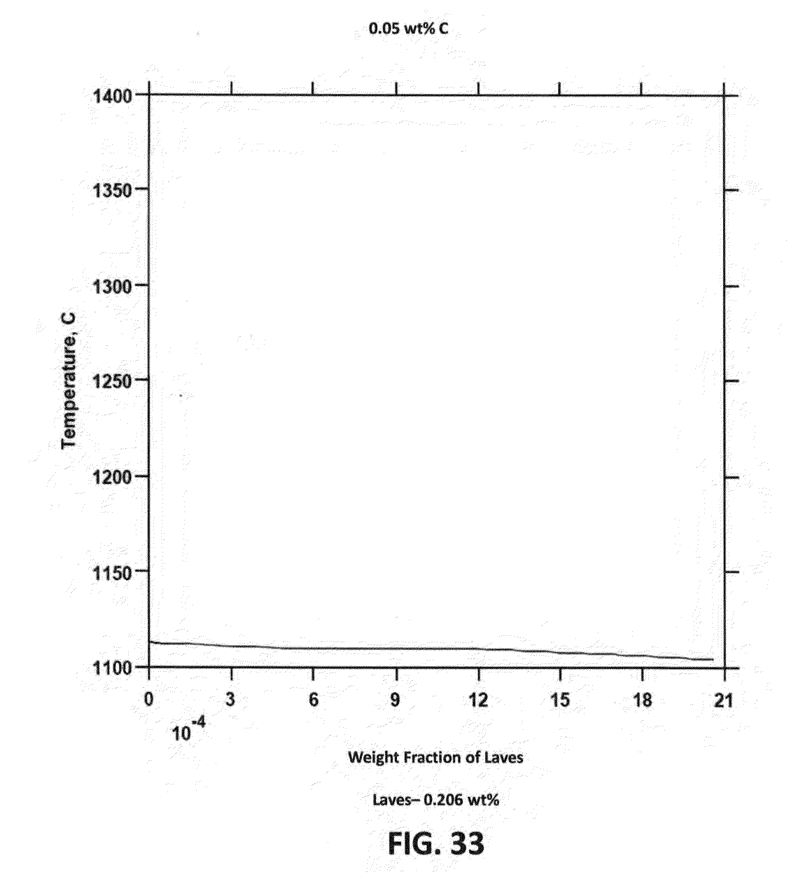

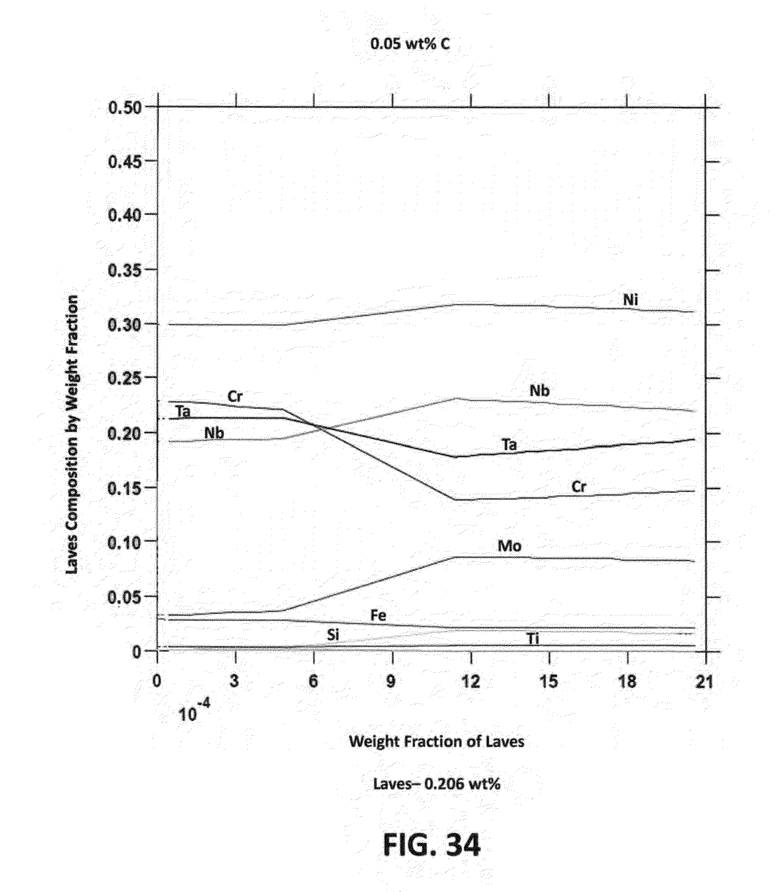

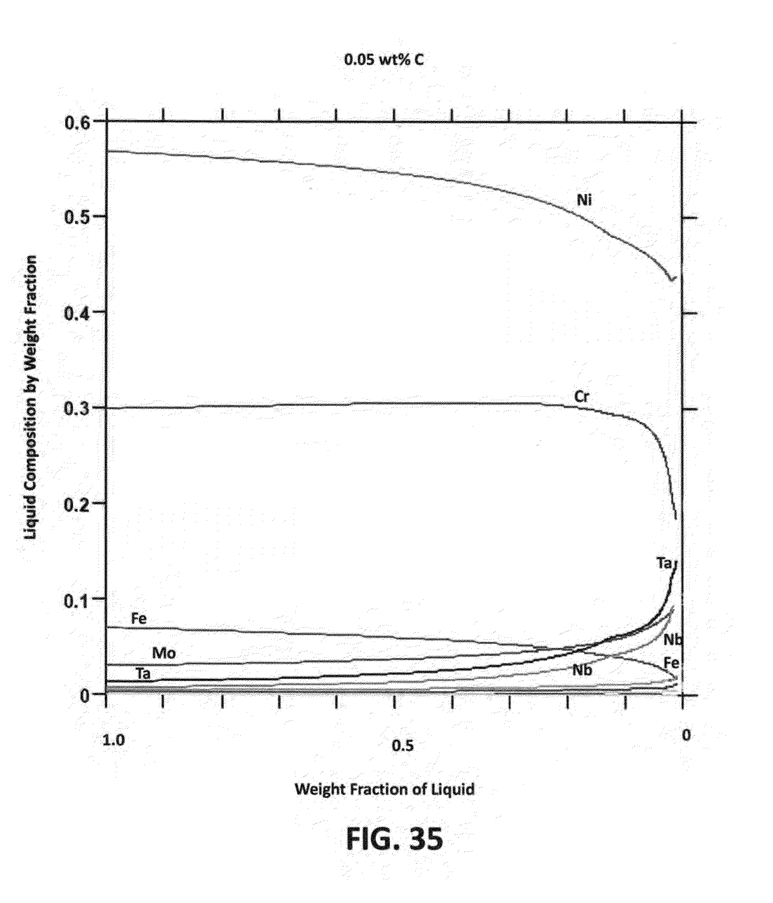

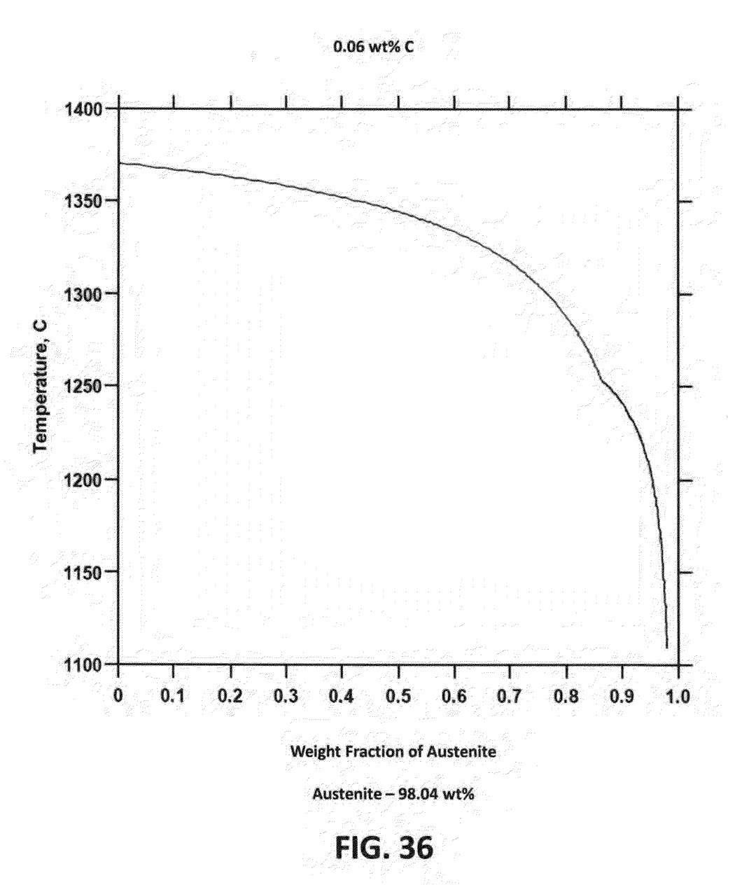

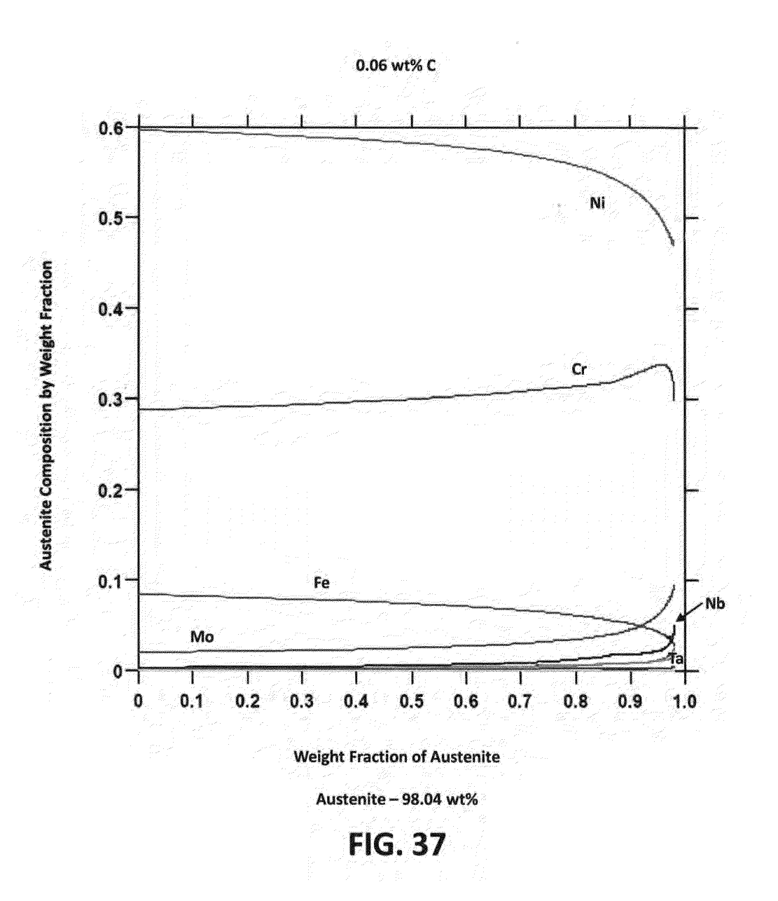

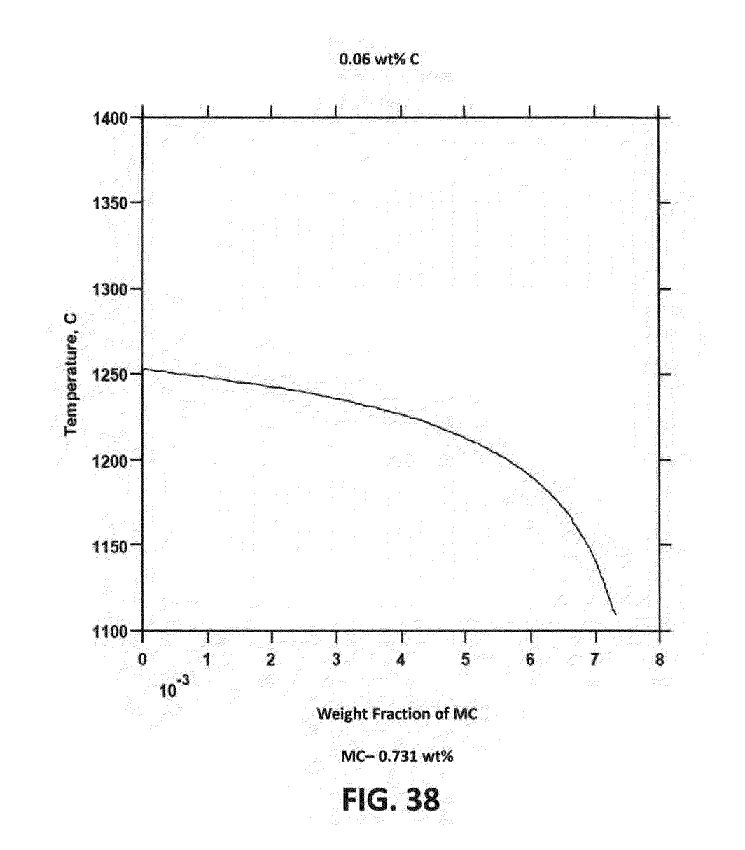

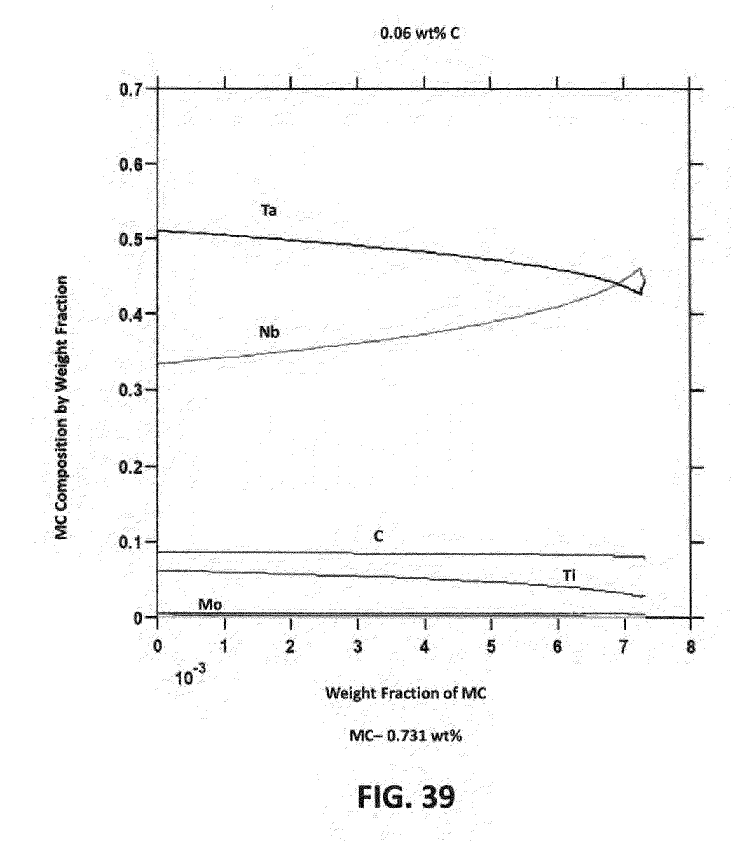

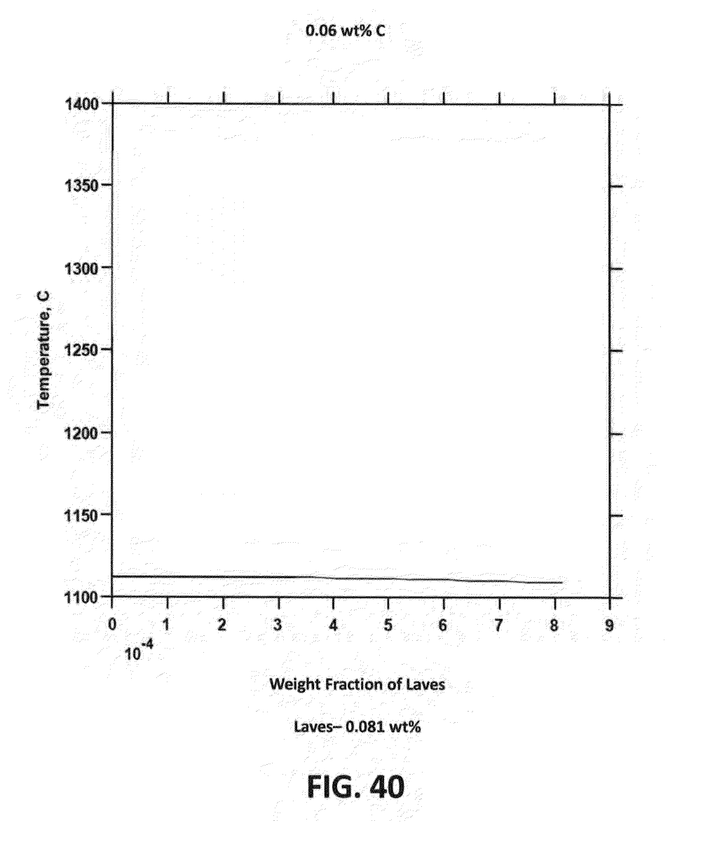

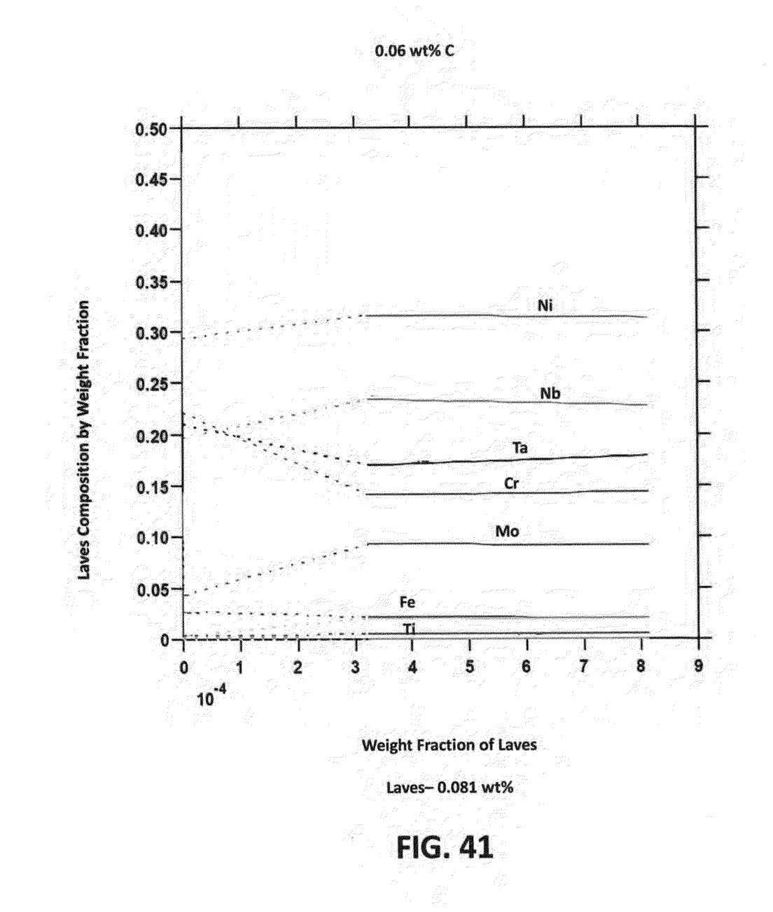

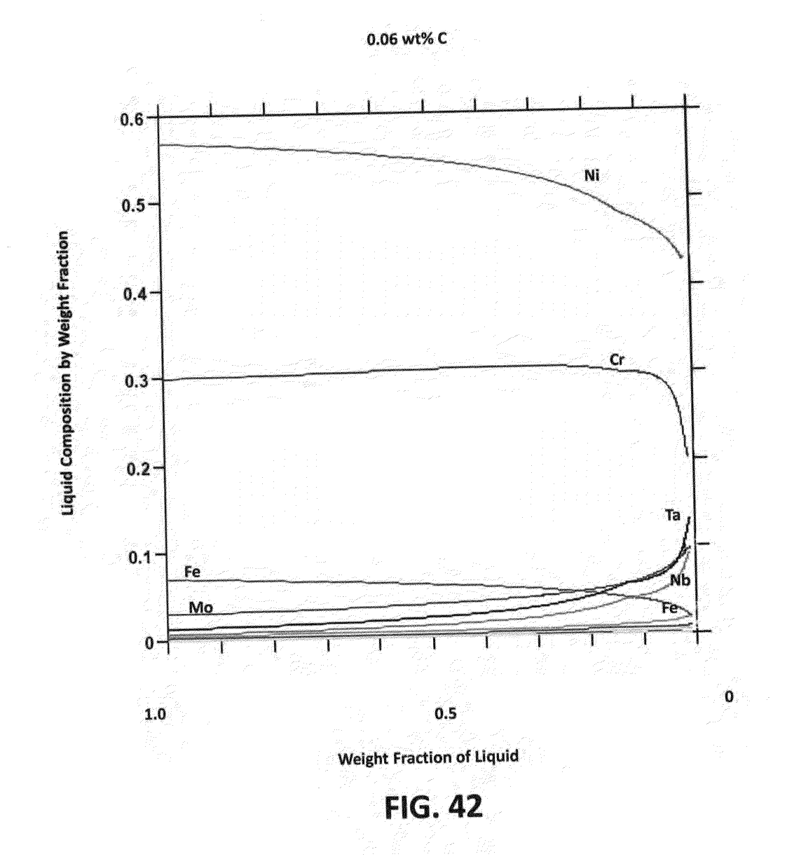

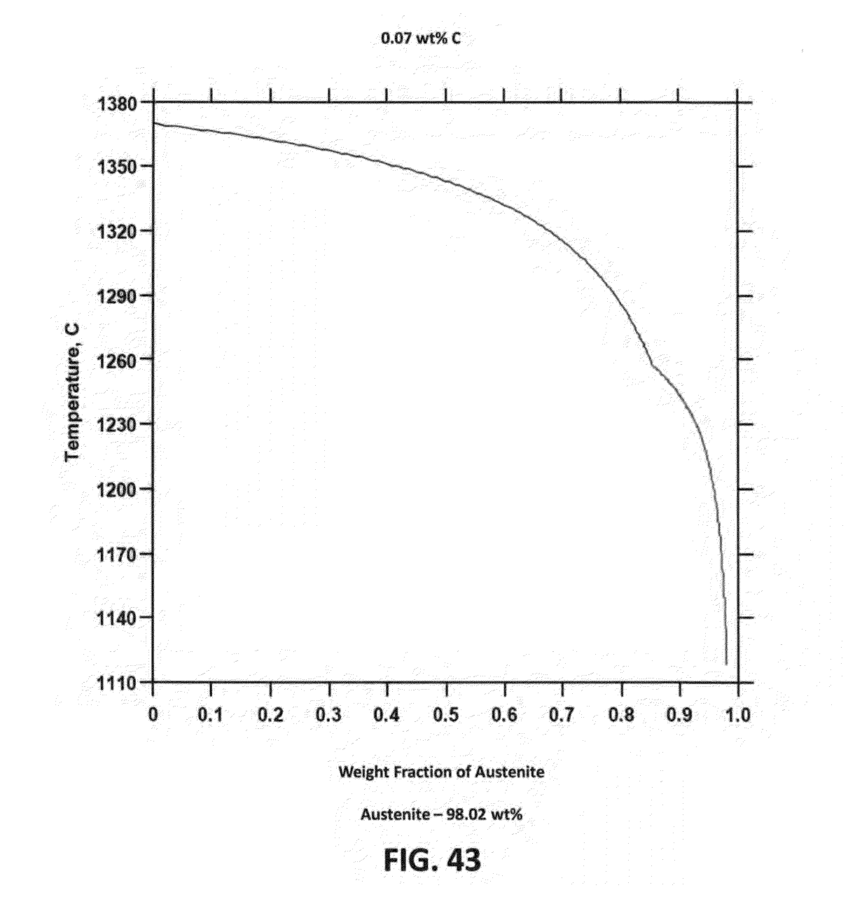

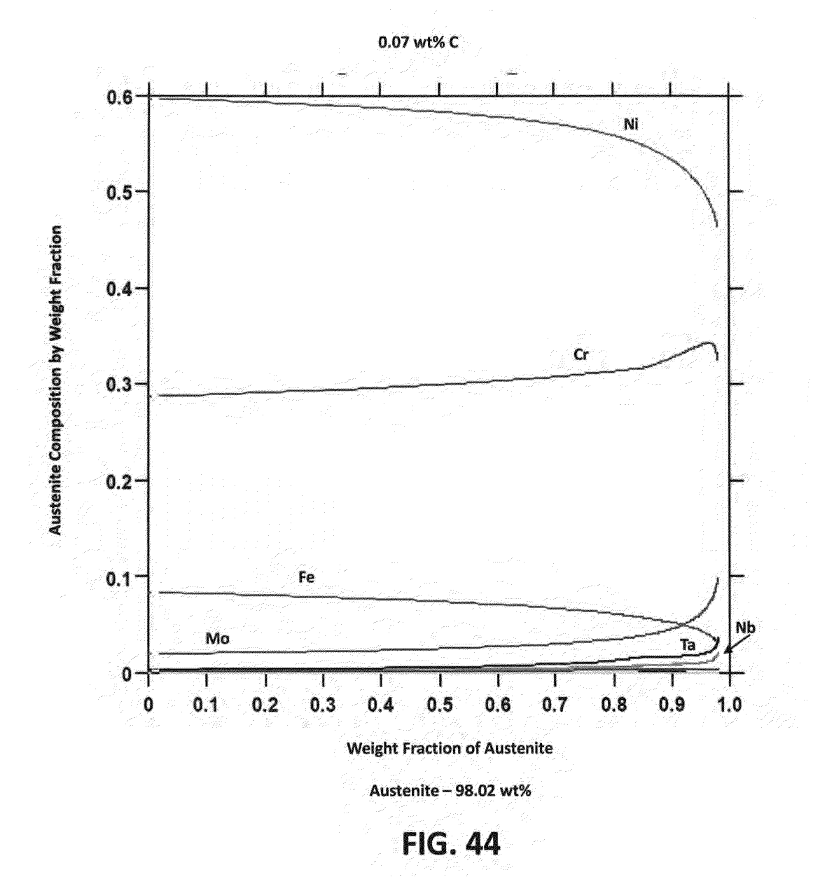

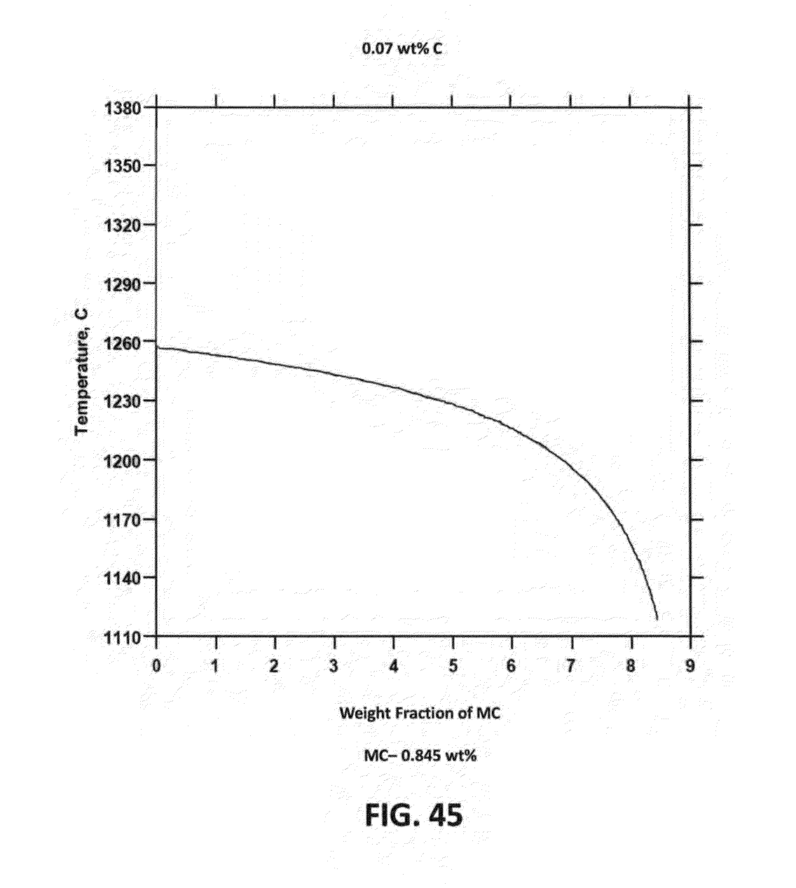

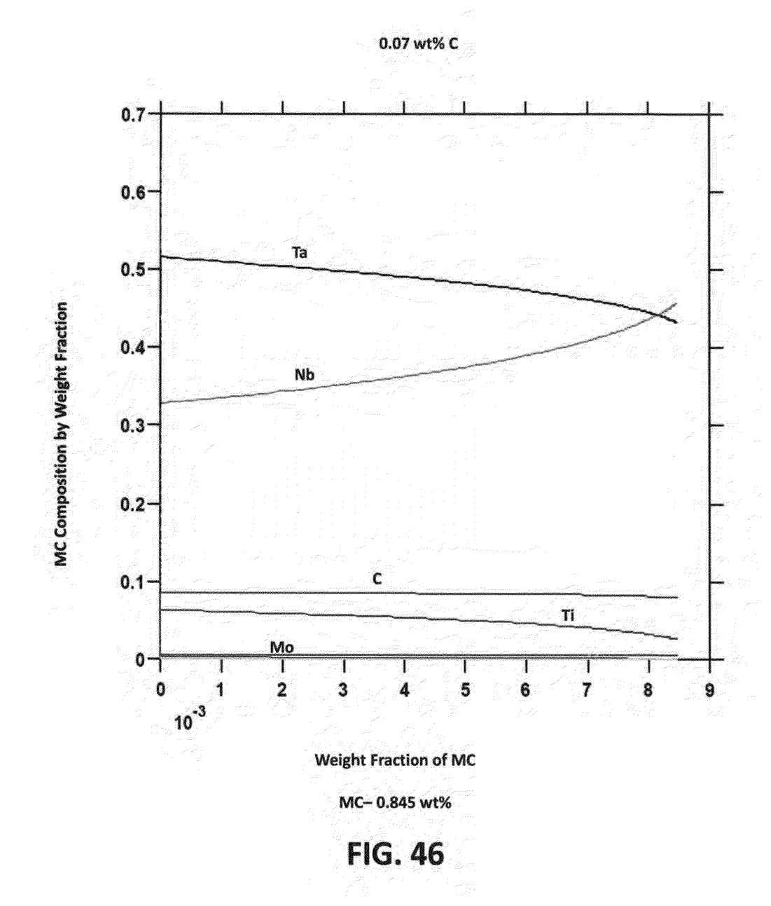

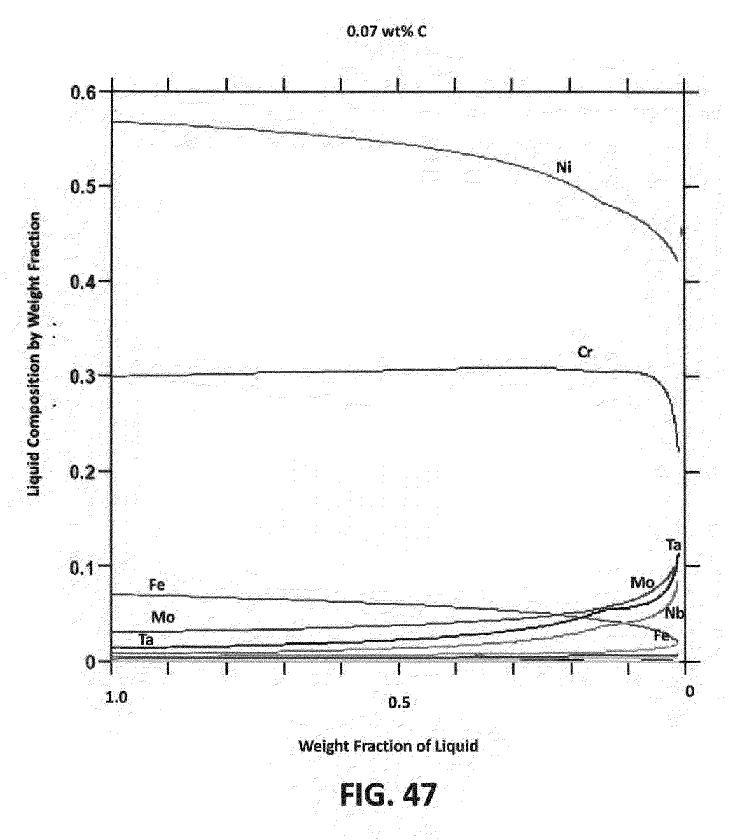

FIGS. 1-47 show thermodynamic data simulating an effect of carbon content on the formation of laves phase. FIGS. 1-47 were calculated using Thermo-Calc thermodynamic software, for an alloy including 29.95 wt % Cr, 0.01 wt % Co, 0.75 wt % Nb, 0.24 wt % Ti, 0.14 wt % Al, 7 wt % Fe, 3 wt % Mo, 0.17 wt % Si, 1.36 wt % Ta, 0.5 wt % Mn, 0.03 wt % Cu, and varying amounts of carbon from 0.01 to 0.07 wt %.

FIGS. 1-47 show that, according to the thermodynamic data, increasing carbon content of the welding filler metal decreases the tendency to form laves phase until 0.07% is reached upon which laves phase is eliminated under equilibrium conditions. With laves phase minimized or substantially eliminated, the solidification temperature range (STR) is minimized and the hot cracking resistance is optimized. The thermodynamic data also supports that niobium and tantalum, in particular, would tend to segregate between the solidifying matrix phase and the liquid phase, thereby enriching interdendritic liquid regions with niobium and tantalum. As the carbon content increases, the thermodynamic data supports that increasing amounts of MC carbides would be formed and that concentrations of niobium and tantalum would be decreased in the last portions of the liquid phase to solidify.

Thus, high carbon contents are beneficial for reducing the tendency to form laves phase to thereby improve the hot cracking resistance. Accordingly, the carbon content is controlled to be at least 0.040%, preferably at least 0.045%, more preferably at least 0.050%, more preferably at least 0.055%, more preferably at least 0.060%, more preferably at least 0.065%, and more preferably at least 0.070%.

However, excessive amounts of carbon have a detrimental effect on the formation of other unwanted carbides such as M23C6, which have a high concentration of chromium. When carbides such as M23C6 are present, they deplete the regions adjacent to grain boundaries of the chromium content that is beneficial for contributing to primary water stress corrosion cracking (PWSCC) resistance. Accordingly, carbon is controlled to be at most 0.090%, more preferably at most 0.085%, and more preferably at most 0.080%.

Manganese (Mn)—

Manganese may be beneficial for deoxidizing the welding filler metal and may be controlled to be at least 0.0010%, preferably at least 0.010%, more preferably at least 0.10%, and more preferably at least 0.20%.

However, the manganese content is controlled to a low level for the following reasons.

As explained above, high levels of carbon are beneficial for reducing the tendency to form laves phase. However, the high levels of carbon tend to have a detrimental effect on the formation of other unwanted carbides such as M23C6, which have a high concentration of chromium.

To overcome the detrimental effect of the increased carbon content of the formation of M23C6 carbides, the amounts of the niobium and tantalum are balanced with the amounts of carbon to ensure that carbon is removed from solution as the weld metal solidifies. In addition, high amounts of manganese encourage the formation of M23C6 carbides. Accordingly, low levels of manganese mitigate the effect of the elevated carbon content on the formation of unwanted carbides such as M23C6. Accordingly, the manganese content is controlled to at most 1.0%, preferably at most 0.75%, more preferably at most 0.50%, and more preferably at most 0.40%.

Aluminum (Al)—

Aluminum may be beneficial for deoxidizing the filler metal and may be controlled to be at least 0.0010%, preferably at least 0.010%, and more preferably at least 0.10%.

However, excessive amounts of aluminum have a detrimental effect on formation of floating oxides and tendency for root cracking. Accordingly, the aluminum content is preferably controlled to be at most 0.50%, preferably at most 0.40%, more preferably at most 0.25%, and more preferably at most 0.15%.

Titanium (Ti)—

Titanium is beneficial for helping to resist PWSSC. However, excessive amounts of titanium have a detrimental effect on formation of floating oxides and tendency for root cracking. Accordingly, the titanium content is preferably controlled to at most 0.50%, more preferably at most 0.40%, more preferably at most 0.35%, and more preferably at most 0.30%.

Boron (B)—

Excessive amounts of boron tend to contribute to solidification cracking. Accordingly, the boron content is preferably controlled to at most 0.015%, more preferably at most 0.0050%, more preferably at most 0.0010%, and more preferably at most 0.0005%.

Zirconium (Zr)—

Excessive amounts of zirconium tend to contribute to detrimental solidification cracking. Accordingly, the zirconium content is preferably controlled to at most 0.020%, more preferably at most 0.010%, more preferably at most 0.0050%, and more preferably at most 0.0010%.

Sulfur (S) may be present as an impurity. Excessive amounts of sulfur have a detrimental effect on solidification cracking. Accordingly, the sulfur content is preferably controlled to at most 0.015%, more preferably at most 0.010%, more preferably at most 0.0050%, and more preferably at most 0.0010%.

Phosphorus (P) may be present as an impurity. Excessive amounts of phosphorus have a detrimental effect on solidification cracking. Accordingly, the phosphorus content is preferably controlled to at most 0.020%, more preferably at most 0.010%, and more preferably at most 0.003%.

Silicon (Si)—

Silicon is helpful for improving puddle fluidity in small amounts. Accordingly, the silicon content is preferably controlled to be at least 0.0010%, more preferably at least 0.010%, and more preferably at least 0.020%.

However, excessive amounts of silicon can lead to increased sensitivity to hot cracking or solidification cracking at higher levels. Accordingly, the silicon content is preferably controlled to at most 0.50%, more preferably at most 0.25%, and more preferably at most 0.15%.

Copper (Cu)—

Copper is beneficial for resistance to corrosion in reducing acids. However, excessive amounts of copper have a detrimental effect on mechanical strength. Accordingly, the copper content is preferably controlled to at most 1.0%, more preferably at most 0.5%, more preferably at most 0.3%, more preferably at most 0.10%, and more preferably at most 0.030%.

Cobalt (Co)—

Cobalt naturally occurs with nickel. However, because of extended half-lives of some isotopes, cobalt is preferably limited to at most 0.20%, more preferably at most 0.10%, more preferably at most 0.05%, and more preferably at most 0.010%.

Tungsten (W)—

Tungsten may be optionally included in the welding filler metal. However, extended half-lives of some isotopes of tungsten have a detrimental effect. Accordingly, the tungsten content is preferably controlled to be at most 1.0%, more preferably at most 0.50%, and more preferably at most 0.25%.

Iron (Fe)—

Iron is beneficial for resistance to long range ordering. When present, the iron content is preferably controlled to be at least 1.0%, more preferably at least 3.0%, more preferably at least 5.0%, and more preferably at least 5.5%.

However, excessive amounts of iron have a detrimental effect on limiting the amount of additional iron dilution that may be acceptable from the welding process. Accordingly, the iron content is preferably controlled to at most 16.0%, more preferably at most 13.0%, more preferably at most 10.0%, more preferably at most 8.0%, more preferably at most 7.0%, and more preferably at most 6.2%.

Nickel (Ni)—

Nickel is beneficial for providing a ductile, corrosion resistant matrix that is capable of providing adequate solubility of the alloying elements. Accordingly, the nickel content is preferably controlled to be at least 52.0%, more preferably at least 54.0%, and more preferably at least 56.0%.

However, excessive amounts of nickel have a detrimental effect on limiting the amounts of other alloying elements. Accordingly, the nickel content is preferably controlled to be at most 62.0%, more preferably at most 61.0%, and more preferably at most 60.0%.

Calcium (Ca)—

Calcium is beneficial for deoxidation and desulfurization. However, excessive amounts of calcium have a detrimental effect on the formation of floating oxides. Accordingly, the calcium content is preferably controlled to be at most 0.010%, and more preferably at most 0.0050%.

Magnesium (Mg)—

Magnesium is beneficial for deoxidation and desulfurization. However, excessive amounts of magnesium have a detrimental effect on the formation of floating oxides. Accordingly, the magnesium content is preferably controlled to be at most 0.020%, more preferably at most 0.010%, and more preferably at most 0.0050%.

Other Elements—

While the invention has been described with reference to preferred compositions, it will be understood by those skilled in the art that various changes may be made without departing from the scope of the invention. However, excessive amounts of any additional elements that deteriorate resistance to ductility-dip cracking (DDC), resistance to hot cracking, or resistance to nuclear primary water stress corrosion cracking (PWSCC) should be avoided. Any elements not recited in the above disclosure are preferably limited to be at most 0.50%, more preferably at most 0.10%, and more preferably at most 0.020%. A total amount of any elements not recited in the above disclosure are preferably limited to at most 0.50%, more preferably at most 0.10%, and more preferably at most 0.020%.

A weld deposit made using the welding filler metal preferably exhibits a tensile strength of 90 ksi or greater, more preferably 95 ksi or greater.

A weld deposit made using the welding filler metal preferably exhibits a ductility as measured by percent elongation of 30% or greater, more preferably 35% or greater.

A weld deposit made using the welding filler metal preferably exhibits a hot cracking resistance as measured by a maximum crack distance (MCD) as determined by the transvarestraint test of 1.0 mm or less at 5% augmented strain, more preferably 0.9 mm or less at 5% augmented strain, more preferably 0.8 mm or less at 5% augmented strain, more preferably 0.7 mm or less at 5% augmented strain, and more preferably 0.6 mm or less at 5% augmented strain.

A weld deposit made using the welding filler metal preferably exhibits a DDC resistance as measured by the strain to fracture (STF) test of 14% or greater threshold strain value at 950° C., more preferably 15% or greater, more preferably 16% or greater, more preferably 17% or greater, and more preferably 18% or greater.

A weld deposit made using the welding filler metal preferably exhibits a PWSCC resistance as measured by the crack growth rate (CGR) under PWSCC conditions of 10⁻⁸ mm/second or less, more preferably 10⁻⁹ mm/second or less. The CGR may be determined under any standard PWSCC testing conditions. For example, the test may be performed using a pre-cracked double bevel weldment subjected to cyclical loading at a target kₘₐₓ of 30 MPa√m at 360° C. in simulated pressurized water reactor (PWR) primary water with 2000 ppm boron, 2 ppm Li, and 25 cc/kg H₂(Ni/NiO line).

A welding filler metal consumable may be made from the welding filler metal described above. For example, the welding filler metal consumable may be in the form of a wire, strip, rod, electrode, pre-alloyed powder, or mixture of powders. In a preferred example, the welding filler metal consumable is in the form a wire or strip having a flux cover. In another preferred example, the welding filler metal consumable is in the form of a sheath having a flux core.

A welding deposit may be formed from the welding filler metal consumable. The weld deposit may be made by providing a welding filler metal consumable as described above and melting and cooling the welding filler metal consumable to create the weld deposit. In a specific example, the melting and cooling of the welding filler metal consumable is accomplished by gas metal arc welding (GMAW). In another specific example, the melting and cooling of the welding filler metal consumable is accomplished by gas tungsten arc welding (GTAW).

A weldment may be formed using the welding filler metal consumable. In a specific example, at least two components are connected by a weld deposit formed using the welding filler metal consumable. The at least two components may include a first component having a first composition different from the welding filler metal consumable and a second component having a second composition different from the first composition and different from the welding filler metal consumable. In another specific example, the weldment may include a substrate having a weld deposit overlay formed thereon using the welding filler metal consumable. The substrate may be a steel substrate.

In a preferred example, the weldment is in nuclear power generation equipment, such as a tubesheet weld overlay of a steam generator of a nuclear reactor or a structural weld overlay on an underlying weld of a pressurizer nozzle of a nuclear reactor.

### Experiment 1

### Transvarestraint Tests

Transvarestraint tests (TVT) were run under a standard range of TVT parameters on exemplary heat HV1779 as well as comparative compositions of 52MSS, 52M, 52i and Kobe 690Nb, having the compositions listed in Table I plus inevitable impurities.

TABLE I

| | Ni | Cr | Fe | Mo | Mn | Nb | Ti | Ta | C | S | Al |
|---|---|---|---|---|---|---|---|---|---|---|---|
| HV1779 | 58.8 | 30.5 | balance | 3.2 | 0.35 | 0.77 | 0.2 | 1.4 | 0.09 | 0.003 | — |
| 52MSS | 58.4 | 29.5 | balance | 3.2 | 0.3 | 2.4 | 0.18 | 0.01 | 0.032 | 0.0002 | — |
| 52M | balance | 30.1 | 8.9 | 0.05 | 0.72 | 0.87 | 0.16 | 0.01 | 0.02 | 0.0005 | — |
| 52i | balance | 26.98 | 2.55 | — | 3.04 | 2.58 | — | — | 0.04 | — | 0.45 |
| Kobe | balance | 29.7 | 8.4 | 0.01 | 0.5 | 0.6 | — | — | 0.03 | — | — |
| 690Nb | | | | | | | | | | | |

Table II below shows the results of the TVT tests on exemplary heat HV1779 run according to the following TVT parameters of Table III.

TABLE II

| | | Maximum |
|---|---|---|
| | | Crack |
| HV1779 | | Distance |
| Strain (%) | # Cracks | (MCD) |
| 1(2) | 0 | 0 mm |
| 2 | 5 | 0.90 mm |
| 3(2) | 4.25 | 0.84 mm |
| 4 | 9.5 | 0.88 mm |
| 5(2) | 10.25 | 0.82 mm |
| 7 | 14 | 0.83 mm |

Number in ( ) is # of samples at strain level

TABLE III
TVT Parameters

| | | |
|---|---|---|
| Current | 160 | A |
| Voltage | ~12 | volts |
| Arc length | 0.08 | in. |
| Travel speed | 5 | in./min/ |
| Bend rate | 2.5 | in./sec. |
| Bead width | ~0.40 | in. |

Table IV below shows the approximate maximum crack distance (MCD) values of the TVT tests for all of the comparative compositions in Table I run under a standard range of TVT parameters.

TABLE IV

| Strain | | | | Kobe |
|---|---|---|---|---|
| (%) | 52MSS | 52M | 52i | 690Nb |
| 1.0 | 0 mm | 0.62 mm | 0.92 mm | 0.18 mm |
| 2.0 | 0.80 mm | 0.70 mm | 0.80 mm | 0.86 mm |
| 3.0 | 1.21 mm | 0.60 mm | 0.98 mm | 0.93 mm |
| 4.0 | | 0.60 mm | 1.08 mm | 0.94 mm |
| 5.0 | 1.20 mm | 0.62 mm | 1.14 mm | 0.96 mm |
| 6.0 | | 0.75 mm | | 1.18 mm |
| 7.0 | 1.25 mm | 0.88 mm | | |

As shown in Tables II and IV, only exemplary heat HV1779 and comparative composition 52M showed a sufficiently low maximum crack distance (MCD) at 5.0% strain, which is representative of substantially improved solidification cracking resistance. However, comparative composition 52M is subject to DDC. Thus, of the materials that are capable of exhibiting ductility dip cracking (DDC) resistance, only exemplary heat HV1779 and comparative composition 52MSS contain sufficient Mo to establish excellent DDC resistance. But only exemplary heat HV1779 has sufficient carbon to suppress the laves phase tendency which allows substantially improved solidification cracking resistance as shown in the transvarestraint results.

### Experiment 2

### SEM Images of Crack Tip of 52MSS

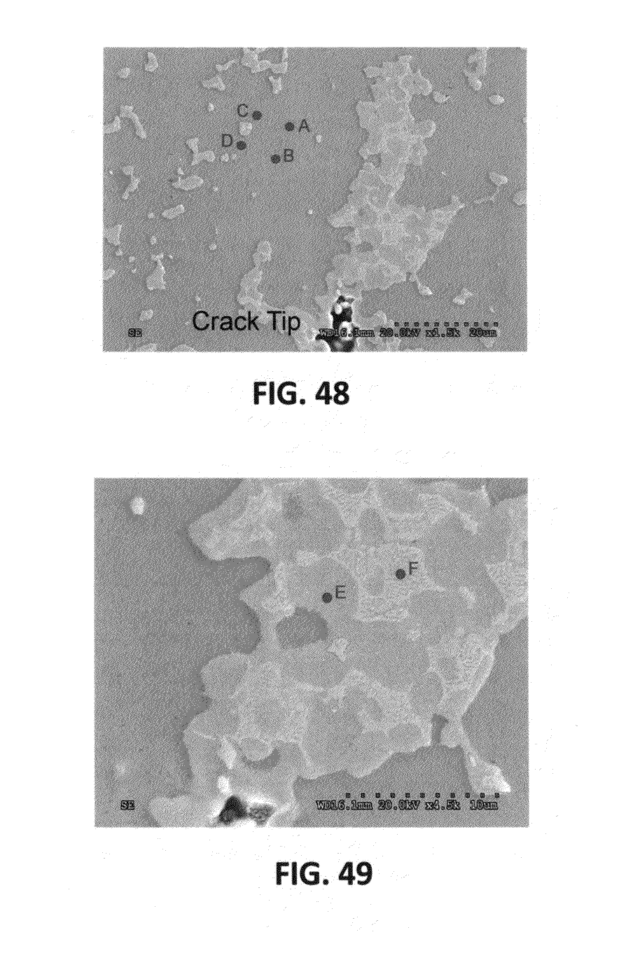

FIGS. 48 and 49 show scanning electron microscopy (SEM) images of a cross section after performing a TVT test on a heat of 52MSS, and showing a crack tip propagating through a region of laves phase.

The compositions at positions A-F of FIGS. 48 and 49 were characterized as follows in Table V, with positions E and F confirming the presence of laves phase at the crack tip.

TABLE V

| | Nb (wt %) | Mo (wt %) | Cr (wt %) | Fe (wt %) | Ni (wt %) |
|---|---|---|---|---|---|
| A | 1.62 | 3.22 | 28.99 | 11.54 | 54.64 |
| B | 2.07 | 3.63 | 29.08 | 11.15 | 54.08 |
| C | 1.89 | 3.61 | 29.1 | 11.32 | 54.09 |
| D | 3.19 | 4.4 | 29.45 | 10.77 | 52.19 |
| E | 7.68 | 5.73 | 27.87 | 8.96 | 49.76 |
| F | 18.99 | 8.14 | 22.39 | 6.77 | 43.71 |

### Experiment 3

### SEM Images of Crack Tip of HV1779

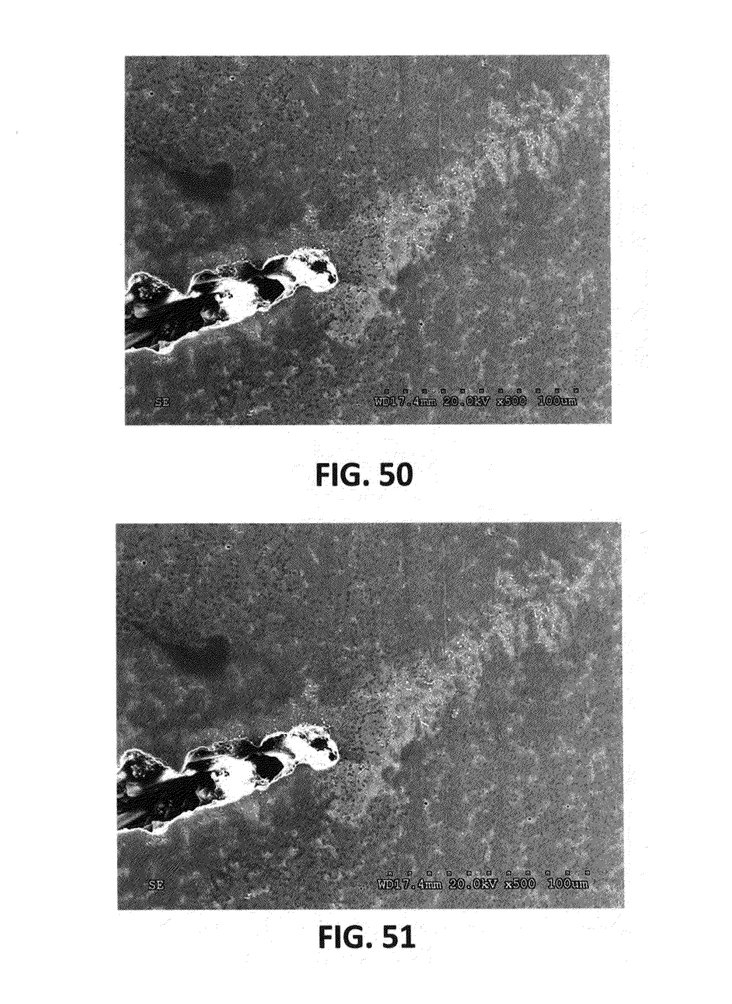

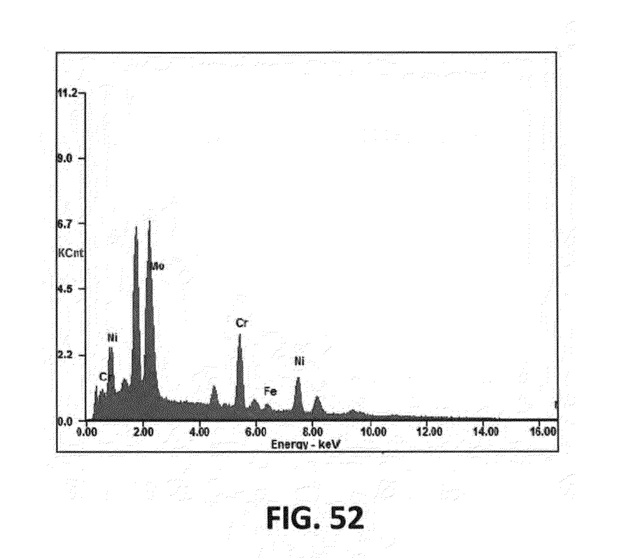

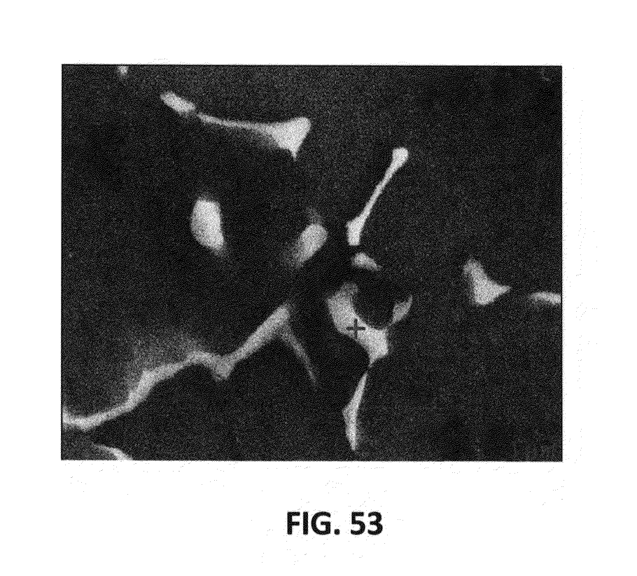

FIGS. 50 and 51 show SEM images of a cross section after performing a TVT test on exemplary heat HV1779. As shown, there was very little secondary phase in the alloy. As typical, there was some concentrated second phase around the crack tip. According to Energy Dispersive X-ray Spectroscopy (EDS) results performed on multiple second phase particles (for example, see FIGS. 52 and 53), the particles around the crack tip appeared to be a (Ta, Mo, and perhaps Nb) type carbides. However, because the particles were so small, the identification could not be considered conclusive. No evidence of laves phase was found.

Thus, the SEM images and particle characterization of Experiments 2 and 3 confirm the presence of laves phase in comparative composition 52MSS and the absence of detected or detectable amounts of laves phase in exemplary heat HV1779.

While the invention has been described with reference to preferred embodiments, it will be understood by those skilled in the art that various changes may be made without departing from the scope of the invention. Therefore, it is intended that the invention not be limited to the best mode contemplated for carrying out this invention.

1. A welding filler metal comprising, by weight percent: chromium of at least 28.0% and at most 31.5%; niobium of at least 0.60%; tantalum of at least 0.010%; molybdenum of at least 1.0% and at most 7.0%; carbon of at least 0.040% and at most 0.09%; manganese of at most 1.0%; balance nickel and inevitable impurities, wherein the sum of niobium and tantalum is at least 2.2% and at most 4.0%.

2. The welding filler metal of claim 1, wherein the carbon content is at least 0.045%.

3. The welding filler metal of claim 1, wherein the carbon content is at least 0.050%.

4. The welding filler metal of claim 1, wherein the carbon content is at least 0.055%.

5. The welding filler metal of claim 1, wherein the carbon content is at least 0.060%.

6. The welding filler metal of claim 1, wherein the carbon content is at least 0.065%.

7. The welding filler metal of claim 1, wherein the carbon content is at least 0.070%.

8. The welding filler metal of claim 1, wherein a weld deposit made using the welding filler metal exhibits a hot cracking resistance as measured by a maximum crack distance (MCD) as determined by the transvarestraint test of 1.0 mm or less at 5% augmented strain.

9. The welding filler metal of claim 1, wherein a weld deposit made using the welding filler metal exhibits a hot cracking resistance as measured by a maximum crack distance (MCD) as determined by the transvarestraint test of 0.9 mm or less at 5% augmented strain.

10. A welding filler metal consumable made from the welding filler metal of claim 1.

11. The welding filler metal consumable of claim 10, wherein the welding filler metal consumable is in the form of a wife, strip, rod, electrode, pre-alloyed powder, or mixture of powders.

12. The welding filler metal consumable of claim 10, wherein the welding filler metal consumable is in the form of a wire or strip having a flux cover.

13. The welding filler metal consumable of claim 10, wherein the welding filler metal consumable is in the form of a sheath having a flux core.

14. A welding deposit formed from the welding filler metal consumable of claim 10.

15. A method of making a weld deposit, comprising: providing a welding filler metal consumable of claim 10; and melting and cooling the welding filler metal consumable to create the weld deposit.

16. The method of making the weld deposit of claim 15, wherein the melting and cooling of the welding filler metal consumable is accomplished by gas metal arc welding (GMAW).

17. The method of making the weld deposit of claim 15, wherein the melting and cooling of the welding filler metal consumable is accomplished by gas tungsten arc welding (GTAW).

18. A weldment formed using the welding filler metal consumable of claim 10.

19. The weldment of claim 18, wherein the weldment includes at least two components connected by a weld deposit formed using the welding filler metal consumable.

20. The weldment of claim 19, wherein the at least two components include a first component having a first composition different from the welding filler metal consumable and a second component having a second composition different from the first composition and different from the welding filler metal consumable.

21. The weldment of claim 18, wherein the weldment includes a substrate having a weld deposit overlay formed thereon using the welding filler metal consumable.

22. The weldment of claim 21, wherein the substrate is a steel substrate.

23. The weldment of claim 18, wherein the weldment is in nuclear power generation equipment.

24. The weldment of claim 18, wherein the weldment is in the form of a tubesheet weld overlay, such as a tubesheet weld overlay of a steam generator of a nuclear reactor.

25. The weldment of claim 18, wherein the weldment is in the form of a structural weld overlay, such as a structural weld overlay on an underlying weld of a pressurizer nozzle of a nuclear reactor.
